(19) United States
(12) Patent Application Publication
(10) Pub. No.: US 2024/0235719 A9
(43) Pub. Date: Jul. 11, 2024

(54) DYNAMIC MODULATION AND CODING SCHEME TABLE SWITCHING TO SUPPORT ADDITION OF HIGHER MODULATION ORDERS AND NEW CONSTELLATION TYPES

(71) Applicant: QUALCOMM Incorporated, San Diego, CA (US)

(72) Inventors: Michael LEVITSKY, Rehovot (IL); Daniel PAZ, Geva Carmel (IL); Muhammad Sayed Khairy ABDELGHAFFAR, San Jose, CA (US)

(21) Appl. No.: 18/049,162

(22) Filed: Oct. 24, 2022

(51) Int. Cl. H04L 1/00

(52) U.S. Cl. CPC H04L 1/0003; H04L 1/0025; H04L 1/0026

(57) ABSTRACT

MAC-CE based dynamic MCS tables switching is introduced to support addition of higher modulation orders and new constellation types. First, a UE receives a RRC configuration indicating a plurality of MCS tables. Next, the UE receives a MAC CE activating a MCS table among the plurality of MCS tables. Doing so allows MCS tables to be dynamically switched via a MAC-CE based activation/reactivation adaptive to current signal to noise (SNR)/spectral efficiency (SPEF) experienced in a downlink and uplink. Finally, the UE communicates data with a base station using a MCS in the activated MCS table.

### TECHNICAL FIELD

The present disclosure generally relates to communication systems, and more particularly, to a wireless communication system between a base station and a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the subject matter described in this disclosure can be implemented in an apparatus for wireless communication at a UE. The apparatus includes a memory and at least one processor coupled to the memory. The processor is configured to receive a RRC configuration indicating a plurality of MCS tables. The processor is also configured to receive a MAC-CE activating an MCS table among the plurality of MCS tables. The processor is further configured to communicate with a base station using an MCS in the activated MCS table.

In another aspect, the subject matter described in this disclosure can be implemented in an apparatus for wireless communication at a base station. The apparatus includes a memory and at least one processor coupled to the memory. The processor is configured to transmit a RRC configuration indicating a plurality of MCS tables. The processor is also configured to transmit a MAC-CE activating an MCS table among the plurality of MCS tables. The processor is further configured to communicate with a UE using an MCS in the activated MCS table.

In another aspect, the subject matter described in this disclosure can be implemented in a method of wireless communication at a UE. The method includes receiving a RRC configuration indicating a plurality of MCS tables. The method also includes MAC-CE activating an MCS table among the plurality of MCS tables. The method further includes communicating with a base station using an MCS in the activated MCS table.

In another aspect, the subject matter described in this disclosure can be implemented in a method of wireless communication at a base station. The method includes transmitting a RRC configuration indicating a plurality of MCS tables. The method also includes transmitting a MAC-CE activating an MCS table among the plurality of MCS tables. The method further includes communicating with a UE using an MCS in the activated MCS table.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example disaggregated base station architecture.

FIG. 3A is a diagram illustrating an example of a first frame, in accordance with various aspects of the present disclosure.

FIG. 3B is a diagram illustrating an example of downlink channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink channels within a subframe, in accordance with various aspects of the present disclosure.

FIG. 4 is a diagram illustrating an example of a base station and user equipment (UE) in an access network.

FIG. 5 illustrates examples of different MCS tables.

FIG. 6 illustrates an example of a plurality of configured MCS tables for dynamic switching.

FIG. 7 illustrates a call flow diagram between a base station and a UE.

FIGS. 8 through 13 illustrate example flowcharts illustrating methods of wireless communication at a UE.

FIGS. 14 through 16 illustrate example flowcharts illustrating a method of wireless communication at a BS.

FIG. 17 is a diagram illustrating an example of a hardware implementation for an example apparatus.

FIG. 18 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Aspects of the present disclosure allow for a more efficient usage of existing MCS s (MCS table options) since MCS tables currently may not be dynamically switched via a RRC based reconfiguration without imposing an interruption to a UE communication link. For instance, aspects of the present disclosure suggest that a plurality of MCS tables will be RRC configured and one of them can be dynamically activated based on receiving an activating medium access control (MAC) control element (CE) indicating a specific MCS table for activation. Doing so allows MCS tables to be dynamically switched in UL and DL via a MAC-CE based activation/reactivation (synchronous and low latency control signaling) adaptive to current signal to noise ratios (SNR)/spectral efficiency (SPEF) experienced in both downlink and uplink channels correspondingly. The ability to dynamically switch the used MCS table allows using MCS tables covering a reduced operational SNR subranges in each table providing a better MCS resolution within each SNR subrange (via an associated with it MCS table) correspondingly which in turn allows to improve link capacity. Additionally, aspects of the present disclosure can provide a more efficient and flexible support of higher order quadrature amplitude modulation (QAM) options and new constellations types that are yet to be introduced in the specification. Additionally, aspects of the present disclosure can provide a more efficient and flexible support of a variety of channel coding options (e.g., LDPC, Polar, Reed Solomon, BCH or any other low complexity code) or transmission schemes (e.g., multi level coding schemes) to be used adaptively that may be introduced in the specification to support new communication scenarios for different device types, operational restrictions or modes (e.g., reduced power consumption mode).

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

In general, the present disclosure describes techniques for dynamically switching MCS tables to support additions of higher modulation orders and new constellation types. This leads to improved performance for downlink and uplink transmission, improved cell coverage, improved spectral efficiency, and/or improved link reliability. In addition, it would be helpful to allow better flexibility for any future specification evolutions, including higher modulation orders adoption, introduction of additional constellation types (amplitude phase shift keying (APSK), cross quadrature amplitude modulation (QAM), etc.), adoption of multi-level coding (MLC) techniques, and new coding approaches (e.g., new codec types, addition of outer codes, etc.). For example, this disclosure describes techniques for MCS table switching in any device that utilizes wireless communication. Other example benefits are described throughout this disclosure.

5G NR specifications define several MCS tables for use depending on different waveforms used in 5G NR. Some of the MCS tables are defined for a Direct Fourier Transform spread OFDM (DFT-S-OFDM) waveform, some are defined for a cyclic prefix OFDM (CP-OFDM), and others are defined for both waveform options. In one example, each one of the MCS tables are defined to cover essentially a full SNR/SPEF range because there are currently no practical options to dynamically switch MCS tables without a link interruption. Instead, the only current option is to change the MCS table and the waveform through a radio resource control (RRC) reconfiguration. However, the RRC configuration is a nonsynchronous procedure that involves a high latency and introduces a link interruption which is not convenient for practical usage for “on-the-fly” reconfigurations.

Different types of waveforms may be used for UL and/or DL communications. For example, DL communications may use a CP-OFDM waveform (e.g., an OFDM waveform that uses a CP) and UL communications may use the CP-OFDM waveform or a DFT-S-OFDM waveform (e.g., a single-carrier waveform). Current 5G NR specifications define several MCS tables. Some of the MCS tables are defined for DFT-S-OFDM waveform only (relevant for UL), for CP-OFDM (relevant for UL and DL), or for both waveform options (e.g., 256QAM table in UL).

The CP-OFDM waveform may be more convenient for a relatively high SNR and/or associated with a relatively high spectral efficiency as compared to the DFT-S-OFDM waveform. For example, the CP-OFDM waveform may be associated with MCS tables that include more spectrally efficient MCSs (MCS options) relative to the DFT-S-OFDM waveform, and therefore allows a more spectrally efficient operation relative to the DFT-S-OFDM waveform and/or enables multiple layers transmission. Accordingly, the CP-OFDM waveform may be a default waveform in UL (and is the only option for DL) for the majority of UEs in a cell's coverage.

In general, CP-OFDM scheme is a more spectrally efficient option because it is associated with MCS tables that provide mostly a more spectrally efficient MCSs and can be used with multiple layers transmission. Accordingly, CP-OFDM scheme with corresponding MCS tables typically are targeted for a more spectrally efficient or higher SNR regime. For instance, QAM1024, QAM 256, or QAM64LowSE MCS tables can be RRC configured for the CP-OFDM cases in DL.

On the other hand, the DFT-S-OFDM waveform may provide a relative low peak to average power ratio (PAPR) relative to the CP-OFDM waveform, thereby allowing for increased transmit power and better coverage. Moreover, the DFT-S-OFDM waveform may be used with MCS tables that are not applicable for the CP-OFDM waveform, such that the included in MCSs are associated with a relatively lower code rates and/or pi/2 binary phase shift keying (BPSK) modulation supporting lower operational SNR. The DFT-S-OFDM waveform usage is currently limited to a single layer transmission. For example, the DFT-S-OFDM waveform may not be suitable for a cell region associated with high SNR or high spectral efficiency. Accordingly, the DFT-S-OFDM waveform may be used by UEs at a cell's edge, UEs experiencing a poor link budget, and/or low capability UEs (limited to single layer transmission with low constellation orders).

Accordingly, in general, DFT-S-OFDM is coupled mostly to more robust MCS options defined for UL and included in the corresponding MCS tables (e.g., lower code rates and pi/2 BPSK modulation option). DFT-S-OFM is also limited to a single layer transmission and is targeted for a lower spectral efficiency/SNR regime. For example, QAM64LowSE table or 256QAM table can both be RRC configured in UL coupled to DFT-S-OFDM scheme. As another example, Pi/2 BPSK usage is also RRC configured (on top of QAM64LowSE tables) and allows support for an extended range of a low/negative SNR. As another example, two MCS tables may be RRC configured to UE in UL such that a one MCS table may be applicable in a case where DFT-S-OFDM waveform is RRC enabled (e.g., transform precoding is enabled) and the other MCS table is applicable in cases that transform precoding is not enabled (CP-OFDM case) by the RRC configuration.

A UE may use a transmit waveform according to a location of the UE within a cell's coverage. If the UE is mobile, the UE may have different locations within the cell's coverage at different times such that a different transmission scheme may be used by the UE (e.g., at a low-SNR edge of a cell, a mid-SNR edge of the cell, or a high-SNR range of the cell) depending on the location of the UE.

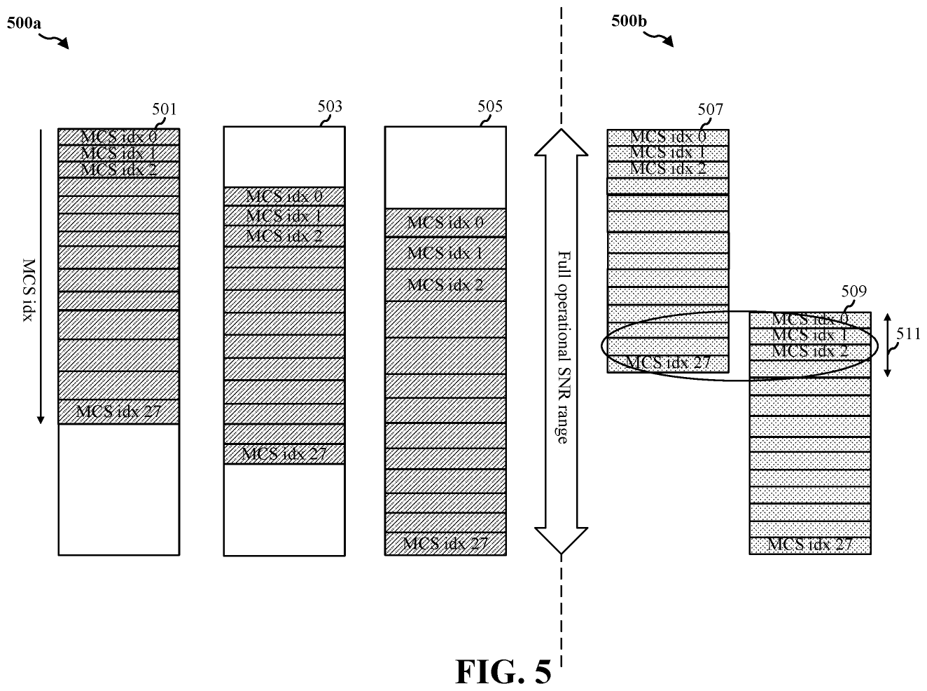

Each of one of the currently defined MCS tables per waveform option targets to cover essentially a full SNR range (e.g., 500a as shown in FIG. 5). For instance, each of the individually defined MCS tables may provide a better “coverage” of MCS options for one of low, mid, or high SNR regimes. Targeting an essentially full SNR range per MCS table is due to the fact that there are currently no practical options to dynamically switch MCS tables. Instead, the only option to change the MCS tables are via RRC reconfiguration.

However, RRC reconfiguration is nonsynchronous and may result in hundreds of milliseconds of latency. Accordingly, during this reconfiguration period, a base station may lack information on the transmission scheme used by a UE. Thus, using RRC reconfiguration for switching MCS tables results in a link interruption that is not practical for dynamic switching. This may affect communication performance/experience on the UE side and, in some cases, cause to a link loss—particularly if the UE is approaching a cell's edge.

In addition, introduction of higher or new constellation orders in the future come at the expense of removing some MCS options in the newly added table (e.g., 256QAM, 1024QAM MCS tables) and adding a few MCS options associated with the newly added constellation order to target a wide SNR range in the addressed MCS table. This approach for MCS tables definition coupled to RRC only options for MCS table configuration limits MCS grid resolution (e.g., link efficiency is degraded) and SNR range effectively supported by the semi-statically configured MCS table (e.g., limits on coverage or max throughput).

A full extension from both sides of the SNR range can also be applicable for high capability UEs depending on channel, instant link budget, UE location and speed, and UE operational mode (e.g., power saving vs. advanced receiver) scenarios. As such, supporting further extended SNR ranges with a single MCS table is not possible without a significantly compromised resolution of MCS options per table (or for some SNR subrange). Improving code rates resolution via introduction of new MCS tables or dynamically switching between already defined MCS tables would result in a link efficiency improvement for the relevant SNR subranges and improved coverage. Thus, a practical technique for dynamically switching MCS tables via a non-RRC based reconfiguration and not via per allocation DCI based MCS table index signaling which is not efficient (not needed for most of the time) may be helpful (e.g., MAC-CE based activation/reactivation).

Accordingly, aspects of the present disclosure allow for a dynamically based MCS table switching option for both downlink and uplink to allow a more efficient and flexible support of higher order QAM options and new constellations types that are expected to be introduced. In one aspect, a RRC configuration may be used to indicate a plurality of MCS tables. In another aspect, a MAC-CE may be used to activate a MCS table among the plurality of MCS tables for communicating with the base station using the MCS in the activated MCS table.

Aspects of the present disclosure describes a dynamic MCS table switching option to provide improved performance for downlink and uplink transmission, improved cell coverage, improved spectral efficiency, and/or improved link reliability. For instance, the present disclosure allows adaptive selection of MCS table with the most appropriate constellation type or max/min constellation order and code rates per scenario from a portfolio of MCS table optimized for different conditions (e.g., channel conditions, UE impairments, power saving mode, power limited regime, etc.). Moreover, it would be helpful to introduce a flexible platform to support any future specification evolutions, including higher modulation orders adoption, introduction of additional constellation types (APSK, cross QAM, etc.), adoption of multi-level coding (MLC) techniques, and new coding approaches (e.g., new codec types, addition of outer codes, etc.).

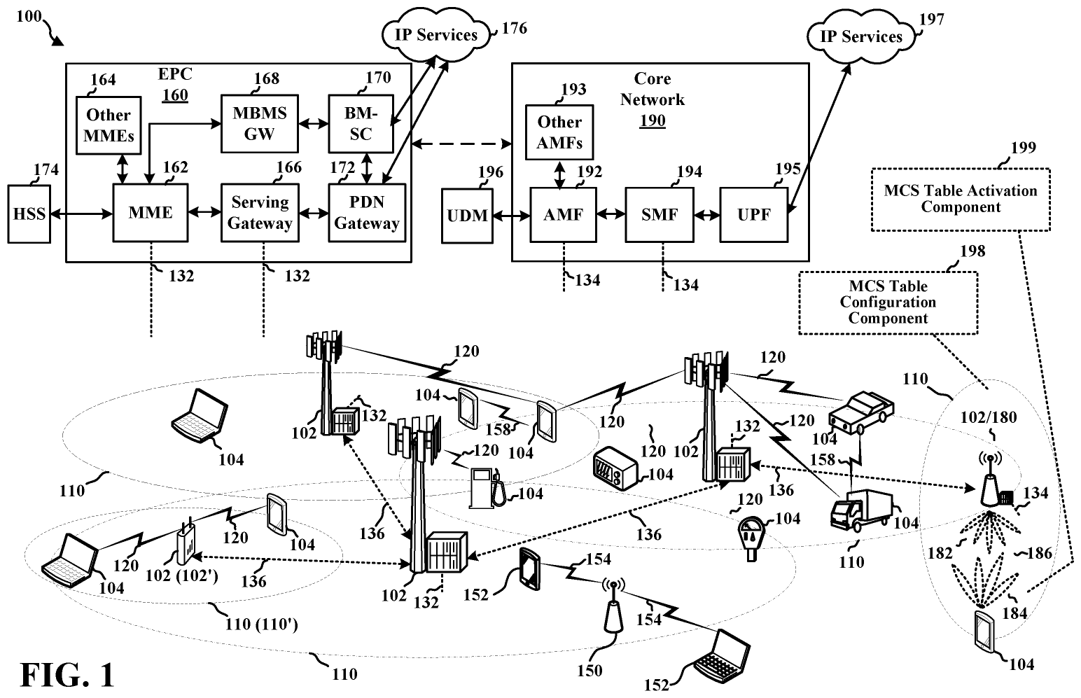

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells, such as high power cellular base stations, and/or small cells, such as low power cellular base stations (including femtocells, picocells, and microcells).

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as the Next Generation Radio Access Network (RAN) (NG-RAN), may interface with a core network 190 through second backhaul links 134. In addition to other functions, the base stations 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

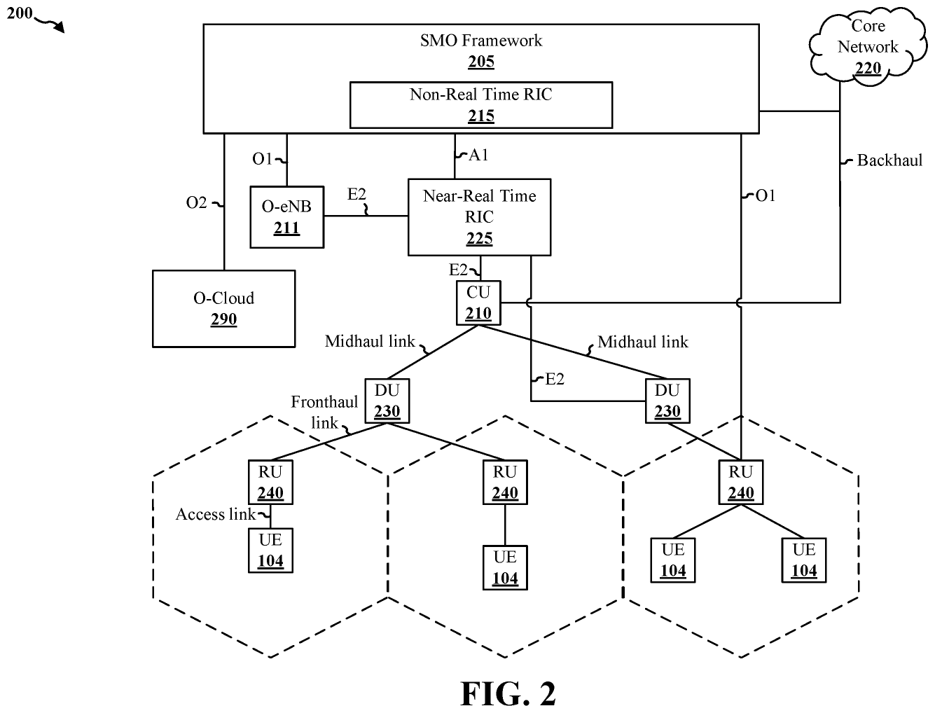

At least some of the base stations 102 configured for IAB may have a split architecture including multiple units, some or all of which may be collocated or distributed and which may communicate with one another. For example, FIG. 2, infra, illustrates an example disaggregated base station 200 architecture that includes at least one of a central unit (CU) 210, a distributed unit (DU) 230, a radio unit (RU) 240, a remote radio head (RRH), a remote unit, and/or another similar unit configured to implement one or more layers of a radio protocol stack.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cells and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances, in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102 may be implemented as a macro base station providing a large cell or may be implemented as a small cell 102′ having a small cell coverage area. Some base stations 102 may operate in a traditional sub-6 GHz (or sub-7 GHz) spectrum, in mmW frequencies, and/or near-mmW frequencies in communication with the UE 104. When such a base station operates in mmW or near-mmW frequencies, the base station may be referred to as a mmW base station 180. The mmW base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 200 may be configured to utilize a protocol stack that is physically or logically distributed among two or more units (such as one or more central units (CU), one or more distributed units (DUs), or one or more radio units (RUs)). In some aspects, a CU 210 may be implemented within a RAN node, and one or more DUs 230 may be co-located with the CU, or alternatively, may be geographically or virtually distributed throughout one or multiple other RAN nodes. The DUs may be implemented to communicate with one or more RUs 240. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

In certain aspects, the base station 102/180 may include a MCS Table Configuration Component 198 that is configured to: transmit a radio resource control (RRC) configuration indicating a plurality of Modulation and Coding Scheme (MCS) tables; transmit a medium access control (MAC) control element (MAC-CE) activating a MCS table among the plurality of MCS tables; and communicate with a UE using an MCS in the activated MCS table.

In certain aspects, the UE 104 may include a MCS Table Activation Component 199 that is configured to: receive a radio resource control (RRC) configuration indicating a plurality of Modulation and Coding Scheme (MCS) tables; receive a medium access control (MAC) control element (MAC-CE) activating an MCS table among the plurality of MCS tables; and communicate with a base station using an MCS in the activated MCS table.

FIG. 2 shows a diagram illustrating an example disaggregated base station 200 architecture. The disaggregated base station 200 architecture may include one or more CUs 210 that can communicate directly with core network 190 via a backhaul link, or indirectly with the core network 190 through one or more disaggregated base station units (such as a Near-Real Time RIC 225 via an E2 link, or a Non-Real Time RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 187 via respective fronthaul links. The RUs 240 may communicate respectively with UEs 104 via one or more radio frequency (RF) access links. In some implementations, the UE 104 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements, which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include the Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

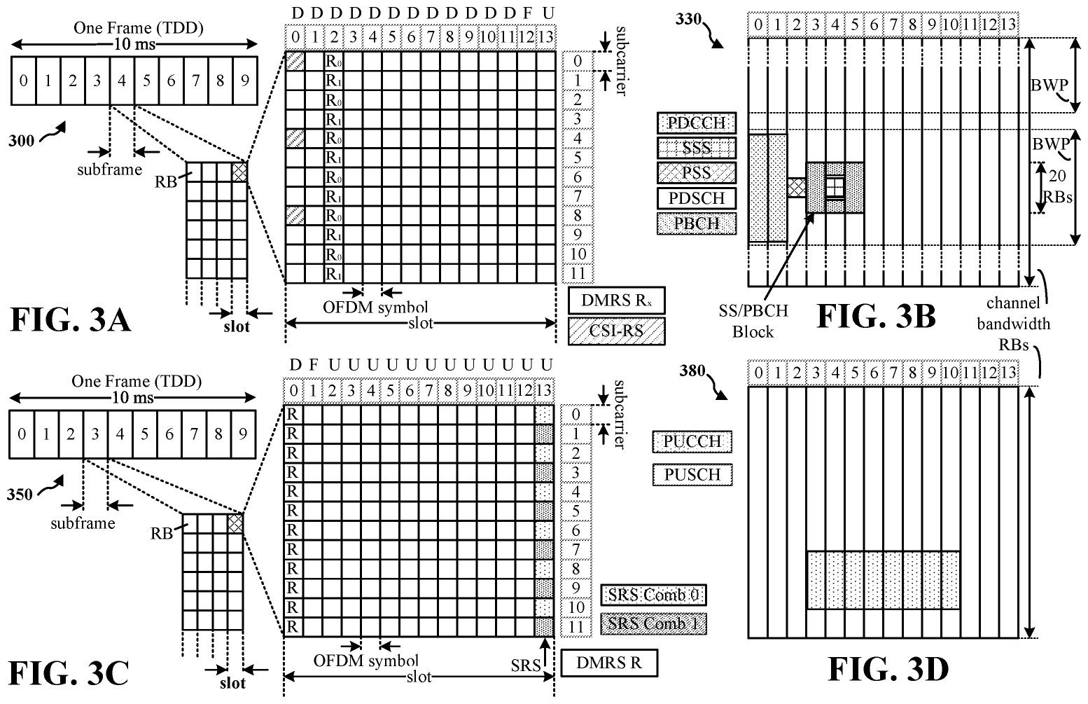

FIG. 3A is a diagram 300 illustrating an example of a first subframe within a 5G NR frame structure. FIG. 3B is a diagram 330 illustrating an example of downlink channels within a 5G NR subframe. FIG. 3C is a diagram 350 illustrating an example of a second subframe within a 5G NR frame structure. FIG. 3D is a diagram 380 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 3A and 3C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix CP-OFDM symbols. The symbols on uplink may be CP-OFDM symbols (for high throughput scenarios) or DFT-s-OFDM symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RB s in the system bandwidth and a system frame number (SFN). The physical downlink shared channel (PDSCH) carries user data, broadcast system information not transmitted through the PBCH such as system information blocks (SIB s), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 3D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

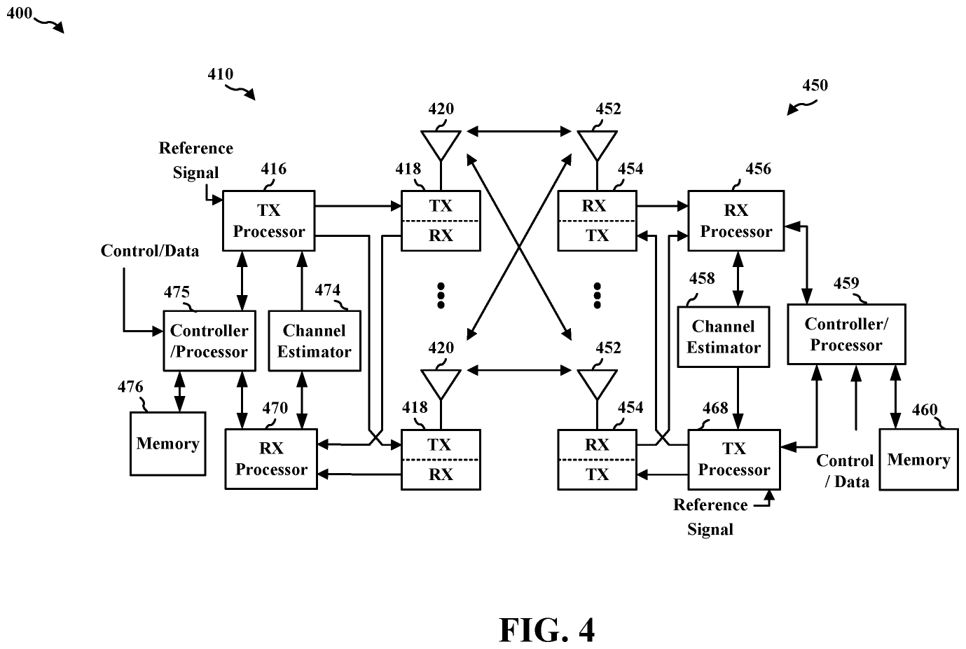

FIG. 4 is a block diagram of a base station 410 in communication with a UE 450 in an access network 400. In the downlink, IP packets from the EPC 160 may be provided to a controller/processor 475. The controller/processor 475 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 475 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate a radio frequency (RF) carrier with a respective spatial stream for transmission.

At the UE 450, each receiver 454RX receives a signal through at least one respective antenna 452. Each receiver 454RX recovers information modulated onto an RF carrier and provides the information to the receive (RX) processor 456. The TX processor 468 and the RX processor 456 implement L1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements L3 and L2 functionality.

The controller/processor 459 can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the downlink transmission by the base station 410, the controller/processor 459 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The uplink transmission is processed at the base station 410 in a manner similar to that described in connection with the receiver function at the UE 450. Each receiver 418RX receives a signal through at least one respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the uplink, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with the MCS Table Activation Component 199 of FIG. 1.

At least one of the TX processor 416, the RX processor 470, and the controller/processor 475 may be configured to perform aspects in connection with the MCS Table Configuration Component 198 of FIG. 1.

Higher QAM orders (e.g., 4096 QAM) addition may be used for customer premise equipment (CPE)/integrated access and backhaul (IAB)/high capability UEs. Correspondingly, it may be helpful to support a wider SNR range. In addition, coverage enhancement work may result in an extension of the SNR range on the low SNR edge as well.

A fully extended SNR range from both sides may be applicable for high capability UEs depending on channel, instant link budget, UE location and speed, and UE operational mode (e.g., power saving v. advanced receiver) scenarios. Supporting a further extended SNR range with a single MCS table may require a significantly compromised resolution of MCS options per table (or for some SNR subrange). Even for existing MCS tables, if it would be possible to improve code rates resolution via introduction of new MCS tables or to dynamically switch between the already defined tables, it would result in a link efficiency improvement for the relevant SNR subranges or coverage improvement.

Non square constellations (like APSK or cross QAM) may allow some PAPR advantage, improved PN robustness or lower complexity for non-linearities handling are considered for FR2x, subThz, and NTN. Introduction of any of these additional constellation types may require additional MCS tables. These additional MCS tables can be used in other scenarios adaptively under some specific conditions (e.g., SNR/MCS THR, dominant PN impairment scenario, with or without significant nonlinearity impairment+mitigation capability, power saving mode, or the like).

Thus, a dynamic MAC-CE based MCS table switching option is introduced for downlink and uplink to improve link efficiency (e.g., better resolution of MCS grid), improved max throughput (e.g., allowing almost unlimited introduction of a higher order modulations and higher spectral efficiency MCSs in the specification without any involved cost or “penalty”), and improved coverage (e.g., extended list of MCSs for the SNR range). The dynamic MAC-CE based MCS table switching option also allows a more efficient and flexible support of higher order QAM options and new constellation types that are expected to be introduced in 5G NR. The suggested approach may also implement a more efficient usage of already existing MCS table options in addition to a better flexibility for introduction of any new modulation/code/MCS table or related techniques.

FIG. 5 illustrates examples 500a, 500b of MCS tables. Specifically, example 500a depicts a first type of MCS table 501, 503, 505 and example 500b depicts a second type of MCS table 507, 509. Tables corresponding to the tables of FIG. 5 are maintained in (or for) each apparatus that employs the techniques taught herein. It should be appreciated that such a table may take other forms in accordance with the teachings herein. For example, a given table may include other parameters, additional parameters, or both. Also, tables may be associated with different signal quality ranges than those shown. In addition, a different number of tables may be included in a set.

Each MCS table is associated with a different range of SNRs. The MCS table may include a data structure that maps a plurality of sets of MCS parameters to respective index values (e.g., MCS indices). For example, each row of an MCS table, identified by an index value (e.g., an MCS index), may include a set of MCS parameters. A set of MCS parameters may include a modulation order, a target code rate, and/or a spectral efficiency, among other examples.

Example 500a depicts a type of MCS table that covers a wide SNR range (minimum full operational SNR range with some prioritization of low, medium, or high operational SNR depending on the usage scenario). For instance, in the example 500a, MCS tables 501, 503, 505 are each defined to cover a wide operational SNR/SPEF range. Moreover, in example 500a, each MCS table covers a wide or some minimum sufficient operational SNR range but gives more priority for a different SNR/SPEF subrange within a full or extended operational SNR range. Correspondingly, each of the MCS tables from example 500a may provide better “coverage” of MCS options for one of low, mid, or high SNR regimes. For instance, in the example 500a, MCS table 1 501 is prioritized for a lower operational SNR range, MCS table 2 503 is prioritized for mid operational SNR range, and MCS table 3 505 is prioritized for a higher operational SNR range.

While in the example 500a, each MCS table 501, 503, 505 is selected apriori per cell and UE type scenario and each MCS tables is RRC-configured. This means that the MCS tables 501, 503, 505 do not practically support dynamic switching because the only option to change the RRC-configured MCS tables and waveform is via a RRC (e.g., control signaling) reconfiguration which includes a nonsynchronous procedure that involves a high latency (e.g., in hundreds of milliseconds of latency) for reconfiguration. Accordingly, during this reconfiguration period, a base station may lack information on MCS table used by a UE. Using RCC reconfiguration for MCS table switching may result in link interruption and affect a performance of communications and link experience on the UE side, which in some cases may result in a link failure particularly if the UE is approaching a cell's edge. Thus, the current approach for MCS table configuration is not practically convenient for “on the fly” reconfiguration.

Due to the fact that the current approach for MCS table configuration is not convenient for “on the fly” reconfiguration, a dynamic MCS table switching option is introduced. This new dynamic MCS table switching option may support MCS tables covering a more limited SNR range (each one separately) with a better MCS resolution per a corresponding limited range and with an overall extended SNR range support coupled to an ability for dynamic MCS table switching as there is movement between the SNR subranges/tables, as shown below in example 500b.

Similar to example 500a, in example 500b, each MCS tables 507, 509 show a same number of MCSs (or MCS options) per table to allow backward compatibility with the existing DCI formats (e.g., MCS index field) and better resolution of MCS/SPEF grid addressed by each table. For example, the MCS tables 507, 509 may contain 32 MCS options mapped to a 5 bits DCI field. Adding more MCS options per table would require extending the corresponding DCI field accordingly. Alternatively, a lower number of MCS options may also be used (coupled with an ability for dynamic MCS tables switching) which may allow a reduction in MCS field size in the DCI and allow a better resolution of MCS/SPEF grid over an extended operational SNR range addressed by a composite set of MCS tables that can be switched dynamically on the fly adaptively to the operational SNR of the UE link.

Example 500b shows MCS tables 507, 509 that are defined to cover a more limited subrange of operational SNR/SPEF as compared to example 500a. As shown in example 500b, MCS table 1 507 covers a first half of the SNR range and MCS table 2 509 covers a second half of the SNF range. For instance, each MCS table 507, 509 provides a better MCS options granularity under its respective covered SNF/SPEF subrange as compared to the MCS table 501, 503, 505 in example 500a.

In addition, MCS tables 507, 509 in example 500b share a smaller shared range with a partial overlap 511 in the covered SNR/SPEF range on the boundaries of the neighboring subranges covered by different tables (e.g., MCS indices overlap). In example 500b, the partial overlap 511 correspond to a shared MCSs/SNR range overlapping between the MCS tables 507, 509. Correspondingly, at least one MCS in the different MCS tables 507, 509 are associated with a same spectral efficiency range. The partial overlap 511 may be introduced in order to not impose a strict switching time requirements by leaving a sufficient response time for table switching decisions, allowing a hysteresis implementation, and assisting with HARQ retransmissions for HARQ processes having MCS table switching event in the middle.

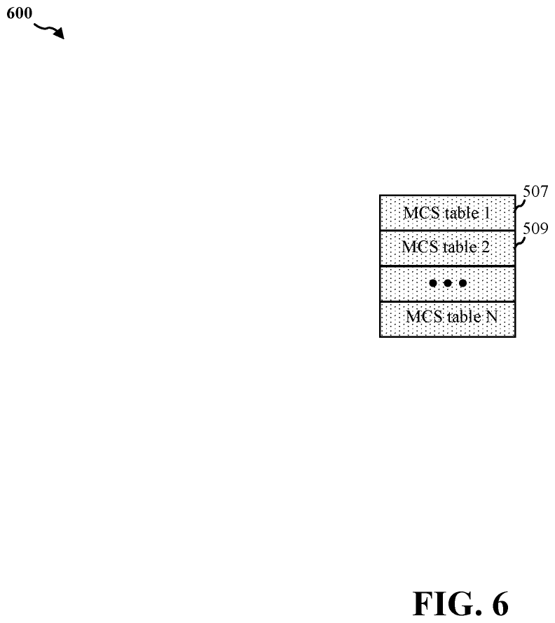

FIG. 6 illustrates an example 600 of configured MCS tables for dynamic switching. As shown in example 600, the plurality of MCS tables (e.g., MCS tables 507, 509 from FIG. 5) are RRC configured for dynamic switching to a UE based a capability of the UE to switch between the plurality of MCS tables. In example 600, the MCS tables 507, 509 are dynamically switched (or activated) via MAC-CE based activation/reactivation adaptive to the current SNR/SPEF conditions experienced in the DL/UL link. One of the MCS tables from the RRC configured list may be dynamically activated or reactivated by MAC-CE signaling. For instance, the MCS table will be switched each time the UE approaches an edge of the currently used MCS table (e.g., first or last MCS index of the MCS table) if there is a more convenient MCS table to be used. Specifically, MCS table switching will be performed adaptively based on a best match between the current experienced SNR/SPEF and SNR/SPEF range supported by the most convenient MCS table from the list of RRC configured MCS tables.

MAC-CE based signaling is used to dynamically switch/reactivate MCS tables for UL and DL because table switching should be a relatively rare event and per allocation DCI based signaling (with MCS table index indication) is not required. MAC-CE based control signaling is a synchronous procedure with a very low latency and signaling overhead since it is signaled only once for some time and not on a per allocation basis like DCI. In addition, DCI based tables switching would be equivalent to increasing the number of MCS options per table (e.g., MCS field extension in DCI). In some aspects, indicated by MAC-CE MCS table for activation (for DL or UL) will become “active” N slots after the slot where ACK for the corresponding PDSCH that carried MAC-CE command is signaled by the UE via UL. For example, a specific activation time of a different MCS table may be signaled by the MAC-CE. Activation time is N slots after ACK signaling in UL for PDSCH allocation in dL that carried the MAC-CE command. The MCS table switching then takes place at the specific slot (deterministic for gNB and the UE) determined by the “activation time” rule. In addition, the existing RRC configuration structure (where a single MCS table is RRC configured in DL and in UL per waveform option) may be used for MCS table indication/configuration before any MCS table activation from the RRC configured plurality of tables for dynamic switching.

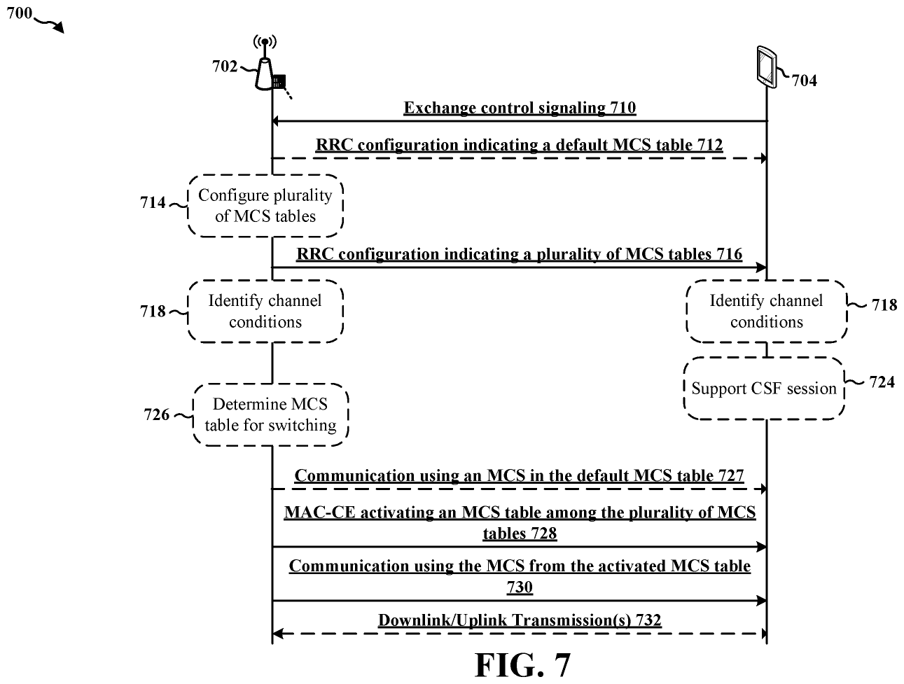

FIG. 7 is diagram illustrating a call flow between a base station 702 and a UE 704. A process flow 700 illustrates an exemplary sequence of operations performed between the base station 702 and UE 704 to support dynamic MCS table switching. For example, process flow 700 depicts operations for dynamically switching MCS tables. It is understood that one or more of the operations described in process flow 700 may be performed earlier or later in the process, omitted, replaced, supplemented, or combined with another operation. Also, additional operations described herein that are not included in process flow 700 may be included in process flow 700.

Initially, UE 704 may transmit control signaling (e.g., RRC control signaling) 710 to the base station 702. In some examples, the control signaling from may indicate a capability to support new types of constellations, some higher constellation orders, codex types, and capabilities for dynamic MCS switching to base station 702. In some examples, base station 702 may support a CSF session for UE 704—e.g., a periodic CSF reporting procedure or an aperiodically triggered CSF reporting procedure.

In some aspects, the UE 704 may receive a an initial RRC configuration prior to the RRC indicating the plurality of MCS tables, wherein the initial RRC configuration indicates the default MCS table 712. The initial RRC configuration may indicate the default MCS table. For example, one of the configured MCS tables from the RRC configuration will be addressed as a default MCS table option to be applicable before the first MAC-CE based activation of one of the included MCS tables in the plurality of MCS tables (e.g., or a list of MCS tables). For example, the default MCS table may be the first configured MCS option (or lowest index of the configured MCS table indexes). Another option is that before any MAC-CE based activation, there will be a specific default MCS table to be used by definition as predefined by a specification. Yet another option is to preserve the existing MCS table RRC configuration option/parameter (for backward compatibility) and this configuration will be applicable before the first MAC-CE activation and a list of RRC configured MCS table options for dynamic switching will be configured separately (both RRC configurations will be provided before entering the connected mode as usual). In some cases, the UE 704 may communicate with the base station using an MCS in the default MCS table 727 prior to receiving a MAC-CE.

In some aspects, base station 702 may activate MLC procedures for transmissions to UE 704. In some aspects, base station 702 may select an MCS table that supports MLC procedures—e.g., based on activating the MLC procedures. An introduction of higher modulation order also gives more potential for MLC which may be beneficially coupled to a very high SPEF regime. MLC may also be beneficial for power reduction for subThz link or any other near additive white gaussian noise (AWGN) channel. MLC adoption will also require a dedicated MCS table addition that can be added to a portfolio of dynamically switched tables.

The base station 702 may configure a plurality of MCS tables 714. The configuration may be a semi-static configuration, such as an RRC configuration. In some aspects, a plurality of MCS tables/IDs will be RCC configured for dynamic switching to a UE based on a capability of the UE to dynamically switch between the plurality of MCS tables.

Next, base station 702 may transmit a RRC configuration indicating a plurality of MCS tables 716 (example 600 from FIG. 6) to UE 704.

In some aspects, base station 702 may identify channel conditions 718. In some aspects, the base station 702 determines a set of transmission characteristics related to a transmission environment of the UE 704. In some aspects, the UE 704 may identify channel conditions 718. The UE 704 determines the set of transmission characteristics related to a transmission environment of the UE 704. In some aspects, the UE 704 may estimate channel conditions between base station 702 and UE 704—e.g., based on received reference signals.

For example, the set of transmission characteristics or channel conditions may include multiple different characteristics that involve the transmission environment associated with the UE and affect the optimal choice of MCS. For example, transmission characteristics may include, but are not limited to, the level of frequency selective fading experienced by a given channel, channel flatness, mobility, link SNR or SPEF, the RB allocation (e.g., narrowband vs. wideband), communication band or type (e.g. Sub6, mmW, SubThz, TDD, FDD, full duplex, . . . ) deployment of the transmitter (e.g., one TRP or joint transmission from multiple TRPs or panels), transmission mode, rank, waveform, accuracy of precoding scheme (e.g., SVD precoding, codebook-based precoding, wideband precoding, open loop MIMO, etc.), non-linearity characteristics, phase noise characteristics.

In some aspects, the UE 704 may support a Channel State Feedback (CSF) session 724. In some aspects, the CSF session may comprise: receiving a downlink control information (DCI) scheduling a CSF report, receiving a channel state information reference signal (CSI-RS), and transmitting a CSF report based on receiving the CSI-RS. In case that a different MCS table is activated during the CSF session, the CSF report may correspond to the MCS table which was active on a slot where the CSI-RS is received, or on a slot where the DCI is received, or on a CSI reference slot associated with the CSF report.

In some aspects, the UE 704 may indicate a request for a change in MCS table using the CSF report. In some aspects, the MCS table switching can be decided by the base station 702. In some aspects, the MCS table switching can be assumed to be triggered or requested by the UE 704. In some aspects, the requested MCS table index/ID can be explicitly reported by the UE 704 as part of the CSF report. This option is more suitable for scenarios where UE 704 has extra information not available to a network or base station 702 regarding some UE impairments or dynamic receiver optimization (e.g., power savings, online training/calibration procedures, etc.). In addition, this option will allow the UE 704 to request MCS tables that not only follow the current SNR/SPEF conditions of the UE 704, but also assume usage of a different constellation type or demodulation/decoding technique like MLC. In some aspects, only MCS table switching request bit will be signaled or reported by a UE 704 to base station 702 coupled or not coupled to CSF. In this case, the MCS table to be switched to may be determined by the base station 702.

In some aspects, the base station 702 determines a MCS table from the plurality of RRC-configured MCS tables 726 based on the identified channel conditions. In some aspects, the base station 702 may select one or more MCS tables from the plurality of RCC-configured MCS tables based at least in part on channel quality indicators (CQIs) received from the UE 704, process (e.g., encode and modulate) the data for each UE based at least in part on MCS table switching indicated to the UE 704 and the MCS table selected for the UE, and provide data symbols for all UEs. In some aspects, the base station 702 maintains MCS tables in memory. For instance, the MCS tables may also be known by the UE. Each MCS table in MCS tables includes a set of MCS values that are selected to optimize or achieve higher performance for a specific channel conditions and based on a set of transmission characteristics related to the transmission environment. In other words, since MCS tables are defined in advance (e.g., same with MCS options in these tables), one of the MCS tables and one of the MCS options from one of the MCS tables is selected for every transmission based on channel, SNR, and other conditions and applicable waveform or transmission scheme.

The base station 702 transmits a MAC-CE activating a MCS table among the plurality of MCS tables 728. In some aspects, one of the MCS tables from the plurality of MCS tables will be dynamically activated/reactivated by a corresponding MAC-CE signal. As mentioned above, MAC-CE based control signaling is a synchronous procedure with a very low latency and signaling overhead. MAC-CE base control signaling is preferable to DCI based table switching because MAC-CE based control signation signaled only once for some time and not on a per allocation basis like DCI. For example, indication by MAC-CE table for activation (for DL or UL) will become “active” N slots after the slot where ACK for the corresponding PDSCH that carried MAC-CE command is signaled by the UE via UL. In some aspects, every time the UE approaches an edge of a currently used MCS table (e.g., first or last MCS index of the table), MCS table will be dynamically switched—assuming there is a more convenient MCS table to be used.

In response to receiving the MAC-CE transmission to activate a MCS table, the UE 704 may communicate with the base station using the MCS in the activated MCS table 730 after the corresponding activation time as described before.

In some aspects, the base station 702 may receive, one or more uplink communications 732 based at least in part on the dynamically switched MCS table that is indicated by the MAC-CE signal. In some aspects, the UE 704 may transmit the uplink communication(s) using a determined transmit waveform type (e.g., the DST-s-OFDM waveform or the CP-OFDM waveform) according to the activated MCS table that may be associated with a specific waveform option. In some aspects, an activation time (e.g., for the UE 704 and base station 702) for the activated MCS table, following reception of a dynamic indication may be based at least in part on a transmission time of acknowledgement feedback, transmitted by the UE 704 for the dynamic indication (MAC-CE). For example, the activation time may be a quantity of slots (e.g., four slots) after an uplink slot in which the acknowledgement feedback is signaled.

In some aspects, the UE 704 will receive or transmit an initial data transmission associated with a hybrid automatic repeat request (HARQ) process using an MCS from a first active MCS table. In the case of an active HARQ processes/retransmission (e.g., scheduled retransmissions when there is no new data indicator in the scheduling DCI) having MCS table switching event before the HARQ process termination or a successful decoding of retransmission, there may be two options. In the first option, all retransmissions after MCS switching event will continue to assume (or use) the MCS table that was “active” during the initial data scheduling/transmission. In the event that a reserved MCS index is used to indicate a different modulation order for the retransmission compared to the initial transmission, this reserved MCS index will also be associated or will follow what is defined in the MCS table that was “active” for the initial transmission. In the second option, all the active HARQ processes will be aborted in case that there is an MCS table switching event in the middle of these HARQ processes. Accordingly, initial data transmission will be repeated for all of them (MAC level reTx) using the new activated MCS table.

In this way, dynamic MCS table switching may provide for synchronous switching between MCS tables. As a result, dynamic MCS table switching may provide improved performance for uplink transmission, downlink transmission, improved cell coverage, improved spectral efficiency, and/or improved link reliability, among other examples.

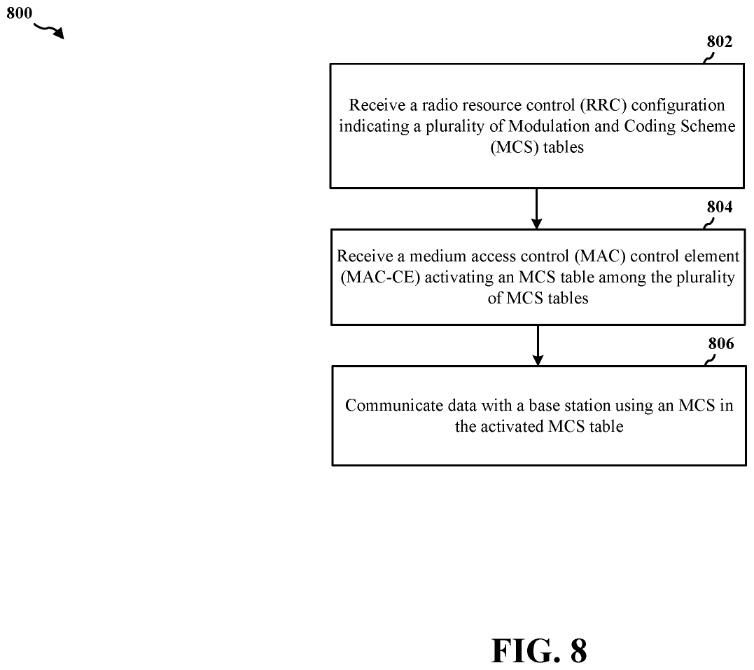

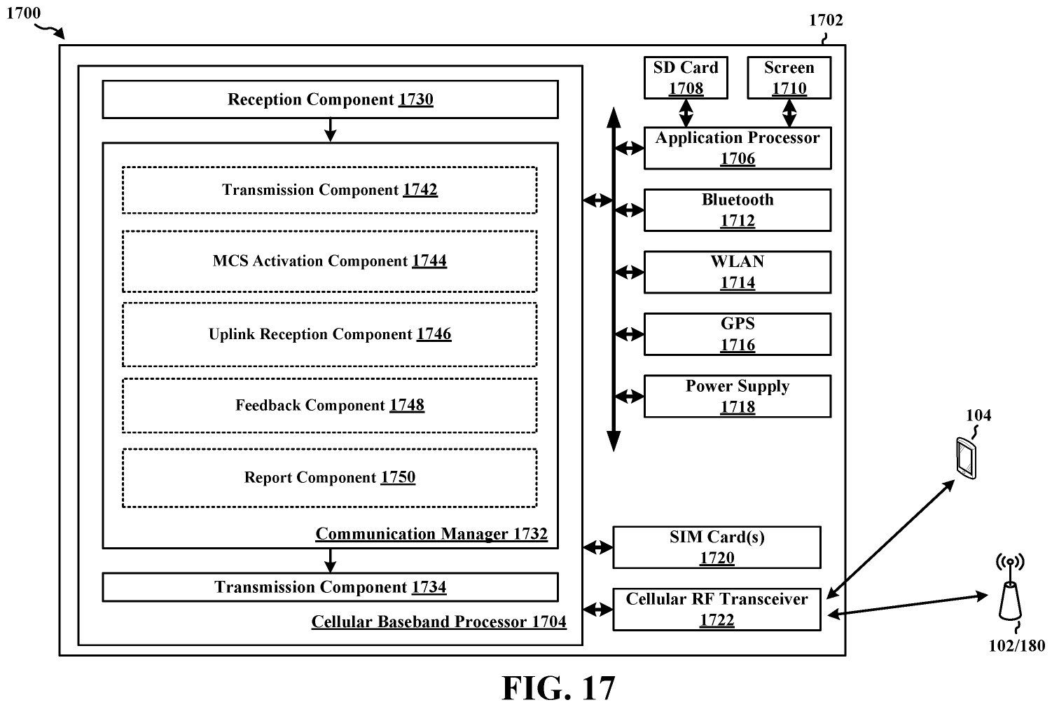

FIG. 8 is a flow chart of a method 800 of dynamic MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 800 may be omitted, transposed, and/or contemporaneously performed. The method allows a UE to dynamically switch MCS tables based on MAC-CE signaling.

The method 800 may be performed by an apparatus, such as MCS table activation component 199, as described above. In some implementations, the method 800 is performed by processing logic, including hardware, firmware, software, or a combination thereof. In some implementations, the method 800 is performed by a processor executing code stored in a non-transitory computer-readable medium (e.g., a memory)

At block 802, the UE may receive a radio resource control (RRC) configuration indicating a plurality of Modulation and Coding Scheme (MCS) tables. In an aspect, the RRC configuration is received based on a capability of the UE to dynamically switch between the plurality of MCS tables. For example, referring to FIG. 7, UE 704 may receive RRC configuration indicating a plurality of MCS tables 716 (e.g., MCS tables 507, 509 in FIG. 5) from base station 702. The UE may indicate its capability to switch between the plurality of MCS tables when the UE and base station exchange control signaling 512.

In some aspects, the plurality of MCS tables are associated with different ranges of signal to noise ratios (SNRs). At least two of the plurality of MCS tables share a partial overlap in ranges of the supported SNRs or corresponding SPEFs. For example, referring to FIG. 5, MCS tables 507, 509 may include MCSs for different SNR ranges. In another aspect, at least one MCS in different ones of the plurality of MCS tables are associated with a same spectral efficiency (SPEF) range. For example, referring to FIG. 5, MCSs having indices referenced by partial overlap 511 may share a same SNR range. In another aspect, the plurality of MCS tables respectively comprise a same quantity of MCS options in each MCS table. For example, referring to FIG. 5, MCS tables 507, 509 may each include 28 MCSs in the illustrated example, 32 MCSs represented by 5 bits in DCI in another example, or any other number of MCSs in a different example. The number of MCSs in MCS tables 507, 509 may be the same as the number of MCSs in MCS tables 501, 503, 505. In some aspects, the plurality of MCS tables includes a first MCS table associated with an enabled value for a pi/2 binary phase shift keying (BPSK) enabling parameter and a second MCS table associated with a disabled value for the pi/2 BPSK enabling parameter. The enabled value being fixed for the first MCS table and the disabled value being fixed for the second MCS table. For example, referring to FIG. 5, MCS table 507 may be configured with a pi/2 BPSK enabling parameter that is enabled, while MCS table 509 may be configured with a pi/2 BPSK enabling parameter that is disabled.

In some aspects, the plurality of MCS tables are associated with different types of constellations (square, non-square), code types (LDPC, polar, Reed-Solomon, etc.), or transmission schemes such as MLC.

At block 804, the UE may receive a medium access control (MAC) control element (MAC-CE) activating a MCS table among the plurality of MCS tables. For example, referring to FIG. 7, UE 704 may receive MAC-CE activating an MCS table among the plurality of MCS tables 728. In some aspects, the MCS table is activated based on a condition of a channel between the base station and the UE. For example, referring to FIG. 7, the base station 702 may determine a MCS table from the plurality of RRC-configured MCS tables 726 based on the identified channel conditions 718.

At block 806, the UE may communicate data with a base station using an MCS in the activated MCS table. For example, referring to FIG. 7, the UE 704 may communicate with the base station 702 using the MCS in the activated MCS table 730.

In an aspect, the MCS table is activated adaptively based on a match between a current signal to noise ratio (SNR) of the apparatus and a SNR range supported by a more convenient MCS table from the plurality of MCS tables, wherein a subsequent MCS table is determined to be more convenient than a previously active MCS table based on overlapping between MCS indexes of the previously active MCS table and the subsequent MCS table and when the current SNR increases toward a last MCS index of the previously active MCS table or decreases toward a first MCS index of the previously active MCS table. For example, referring to FIG. 5, the MCS table switching may be done adaptively based on a best match between the current experienced SNR/SPEF and SNR/SPEF range supported by a most convenient MCS table (if available) from the list of RRC configured MCS tables. In an aspect, the MAC-CE activating the MCS table is received in response to a CSF report of the apparatus indicating an index corresponding to the MCS table recommended by UE. In an aspect, the MAC-CE activating the MCS table is received in response to a request indication from the apparatus to switch to a different MCS table (with or without explicit indication from a UE for the recommended MCS table index).

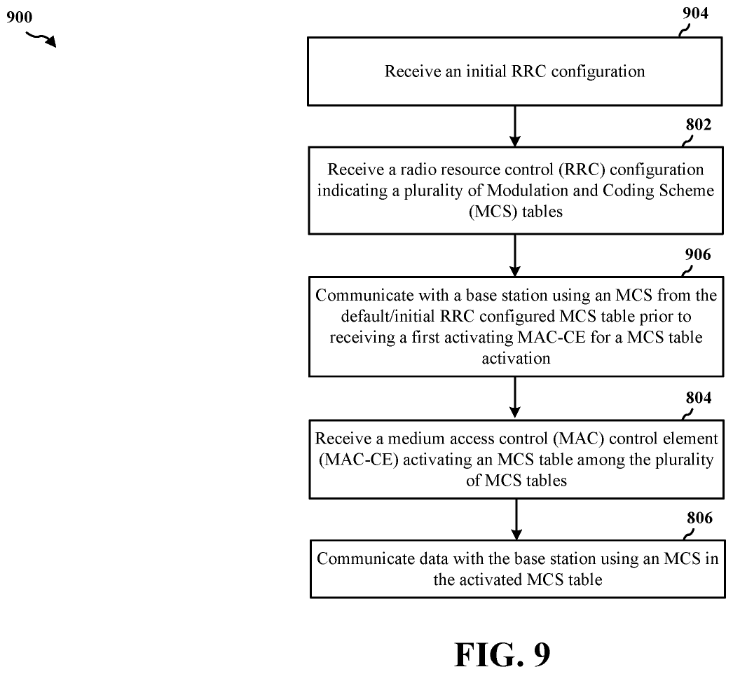

FIG. 9 is a flow chart of a method 900 of dynamic MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 900 may be omitted, transposed, and/or contemporaneously performed. The method allows a UE to dynamically switch MCS tables via MAC-CE.

The method 900 may be performed by an apparatus, such as MCS Table Configuration Component 199, as described above. In some implementations, the method 900 is performed by processing logic, including hardware, firmware, software, or a combination thereof. In some implementations, the method 900 is performed by a processor executing code stored in a non-transitory computer-readable medium (e.g., a memory). In such methods 900, blocks 802, 804, and 806 are performed as described above in connection to FIG. 8.

At block 904, the UE may receive an initial RRC configuration, wherein the initial RRC configuration indicates the default MCS table. In some aspects, the initial (or default) MCS table is configured using the existing RRC configuration structure for backward compatibility. For example, referring to FIG. 7, at 712, the UE 704 may receive the initial RRC configuration indicating the plurality of MCS tables from the base station 702.

At block 906, the UE may communicate with a base station using an MCS in the default MCS table prior to receiving the MAC-CE. For example, referring to FIG. 7, at 727, the UE 704 may communicate with the base station 702 using an MCS from the default (or initial) RRC configured MCS table prior to receiving a first activating MAC-CE for a MCS table activation.

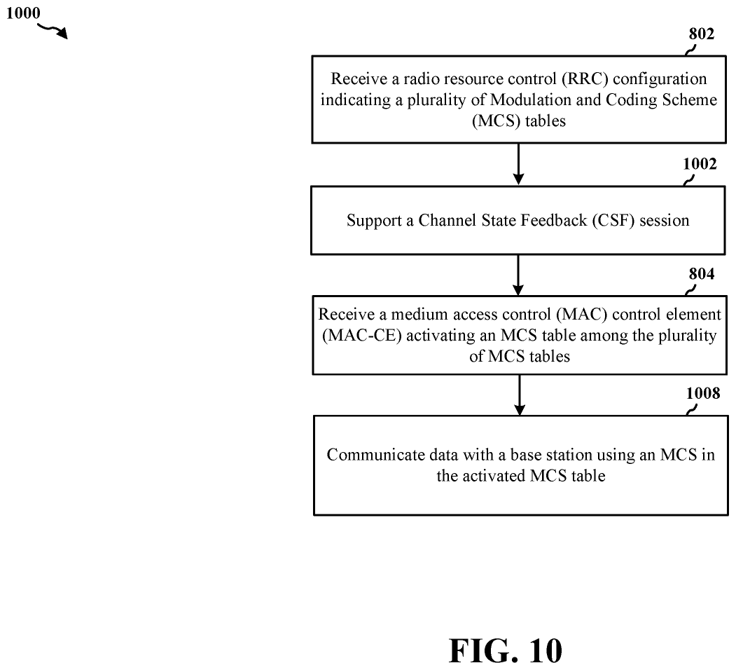

FIG. 10 is a flow chart of a method 1000 of dynamic MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 1000 may be omitted, transposed, and/or contemporaneously performed. The method allows a UE to dynamically switch MCS tables via MAC-CE.

The method 1000 may be performed by an apparatus, such as MCS Table Configuration Component 199, as described above. In some implementations, the method 1000 is performed by processing logic, including hardware, firmware, software, or a combination thereof. In some implementations, the method 1000 is performed by a processor executing code stored in a non-transitory computer-readable medium (e.g., a memory). In such methods 1000, blocks 802, 804, and 806 are performed as described above in connection to FIG. 8.

At 1002, the UE may support a Channel State Feedback (CSF) session. The CSF session may include receiving a DCI scheduling a CSF report, receiving a channel state information reference signal (CSI-RS), and transmitting a CSF report based on receiving the CSI-RS while a different MCS table is activated during the CSF session. In this case, the CSF report corresponds to a MCS table which was active on a slot where the CSI-RS is received, or on a slot where the DCI is received, or on a CSI reference slot associated with the CSF report. In other words, only one of the alternative options listed above will define which MCS table is taken as a reference for CSF report evaluation (e.g., which CQI is reported and how this CQI can be translated to a corresponding MCS from the specific MCS table which is determined as one that is active based on a slot where the CSI-RS is received, on a slot where the DCI is received, or on a CSI reference slot associated with the CSF report). For example, referring to FIG. 7, the UE 704 may support a CSF session 724.

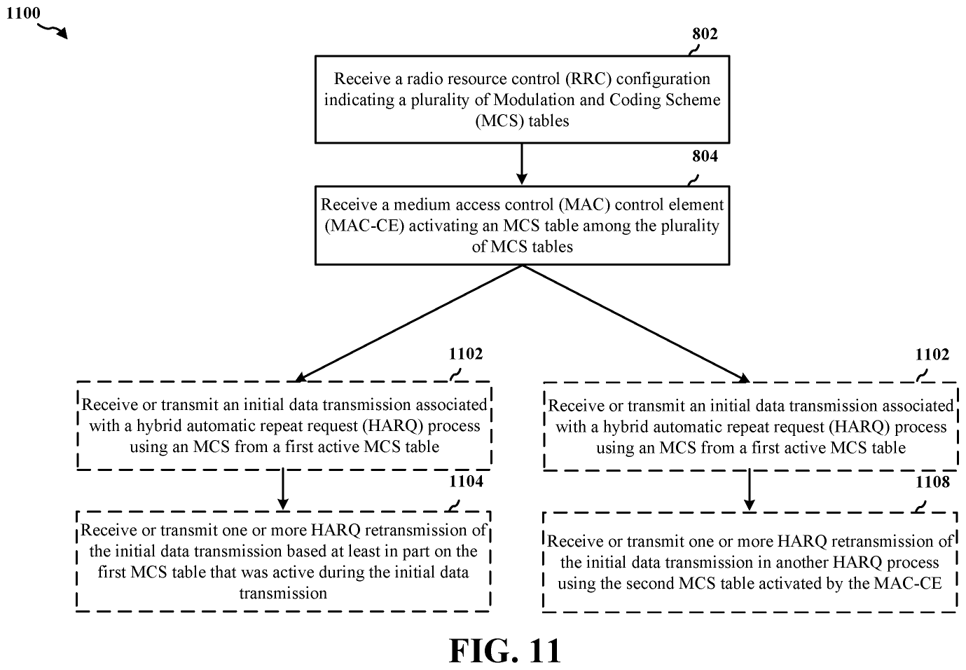

FIG. 11 is a flow chart method 1100 of MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 1100 may be omitted, transposed, and/or contemporaneously performed. The method allows a UE to dynamically switch MCS table via MAC-CE.

The method 1100 may be performed by an apparatus, such as MCS Table Activation component 199, as described above. In some implementations, the method 1100 is performed by processing logic, including hardware, firmware, software, or a combination thereof. In some implementations, the method 1100 is performed by a processor executing code stored in a non-transitory computer-readable medium (e.g., a memory). In such methods 1100, blocks 802, and 804 are performed as described above in connection to FIG. 8.

In a first aspect, at 1102, the UE may receive or transmit an initial data transmission associated with a hybrid automatic repeat request (HARQ) process using an MCS from a first active MCS table. In response to the MAC-CE, a second MCS table signaled by the MAC-CE instead of the first active MCS table is activated prior to a termination of the HARQ process at a slot determined by an activation time of the second MCS table. Specifically, the activation time is N slots after ACK signaling for PDSCH allocation in DL that carried out the MAC-CE command. The MCS table switching then takes place at the specific slot determined by the “activation time” rule. At 1104, the communication with the base station may further comprise receiving or transmitting one or more HARQ retransmission of the initial data transmission based at least in part on the first MCS table that was active during the initial data transmission despite the MCS table switching event.

In a second aspect, at 1102, the UE may receive or transmit an initial data transmission associated with a hybrid automatic repeat request (HARQ) process using an MCS from a first active MCS table. The MAC-CE may activate a second MCS table instead of the first active MCS table being received prior to a termination of the HARQ process. In response to the MAC-CE, the HARQ process is aborted at the moment where the second MCS Table becomes active. At 1108, the communication with the base station further comprises receiving or transmitting the initial data transmission in another HARQ process using the second MCS table activated by the MAC-CE.

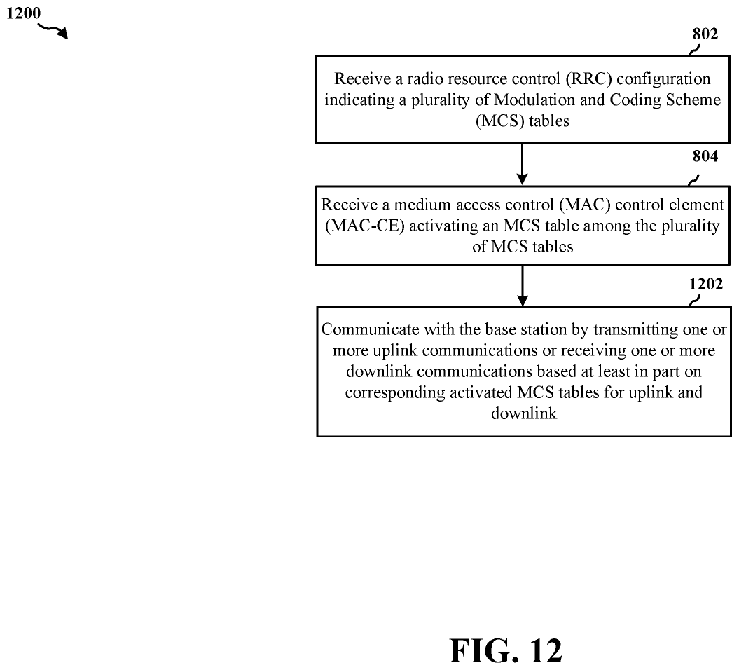

FIG. 12 is a flow chart method 1200 of MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 1200 may be omitted, transposed, and/or contemporaneously performed. The method allows a UE to dynamically switch MCS table via MAC-CE.

The method 1200 may be performed by an apparatus, such as MCS Table Activation component 199, as described above. In some implementations, the method 1200 is performed by processing logic, including hardware, firmware, software, or a combination thereof. In some implementations, the method 1200 is performed by a processor executing code stored in a non-transitory computer-readable medium (e.g., a memory). In such methods 1200, blocks 802, 804, and 806 are performed as described above in connection to FIG. 8.

At 1202, the UE may communicate with the base station by transmitting one or more uplink communications or receiving one or more downlink communications based at least in part on corresponding activated MCS tables for uplink and downlink. For example, referring to FIG. 7, at 732, the UE 704 communicates with the base station by transmitting one or more uplink communications or receiving one or more downlink communications based at least in part on corresponding activated MCS tables for uplink and downlink.

In an aspect, the one or more uplink communications may use a transmit waveform type based at least in part on the activated MCS table.

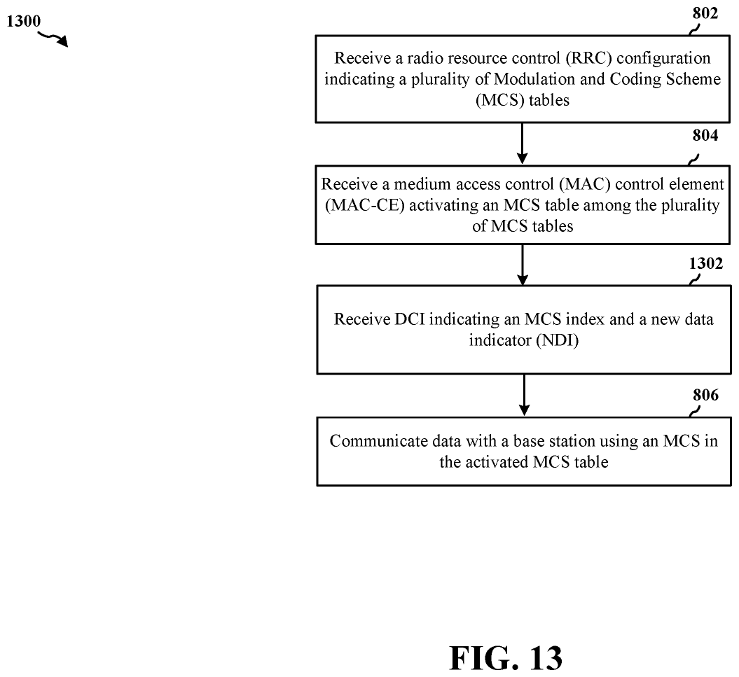

FIG. 13 is a flow chart method 1300 of MCS table switching. The method may be performed by or at a UE (e.g., the UE 104, 450, 704), another wireless communications apparatus (e.g., the apparatus 1702 shown in FIG. 17), or one or more components thereof. According to various different aspects, one or more of the illustrated blocks of method 1300 may be omitted, transposed, and/or contemporaneously performed. The method allows a UE to dynamically switch MCS table via MAC-CE.

The method 1300 may be performed by an apparatus, such as MCS Table Configuration Component 199, as described above. In some implementations, the method 1300 is performed by processing logic, including hardware, firmware, software, or a combination thereof. In some implementations, the method 1300 is performed by a processor executing code stored in a non-transitory computer-readable medium (e.g., a memory). In such methods 1300, blocks 802, 804, and 806 are performed as described above in connection to FIG. 8.

At 1302, the UE may receive downlink control information (DCI) indicating an MCS index and a new data indicator (NDI). The MCS index may be associated with the MCS in a currently active MCS table.

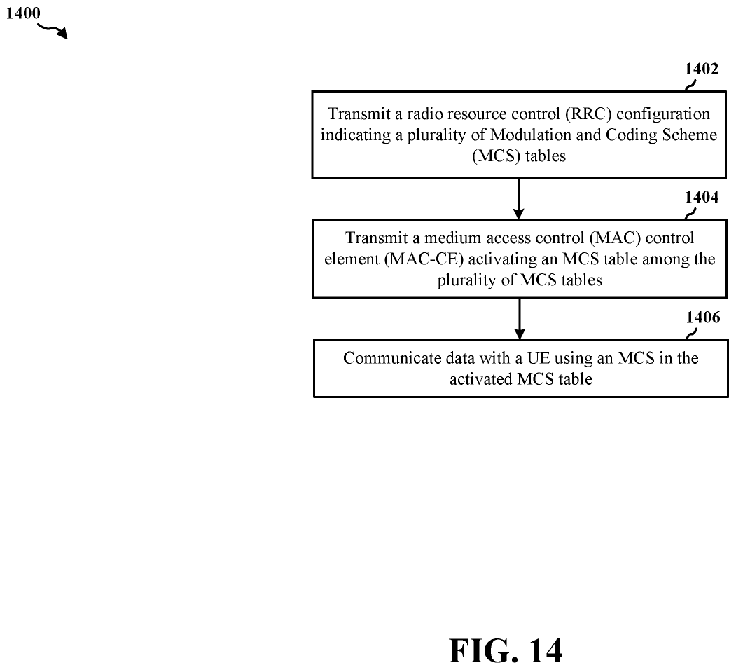

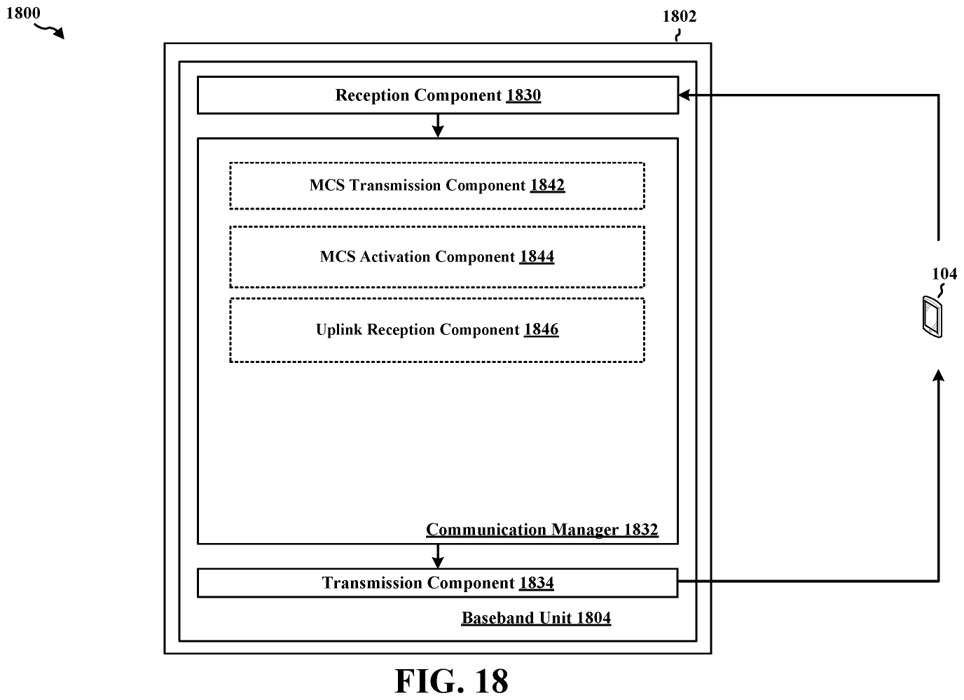

FIG. 14 is a flow chart method 1400 of MCS table switching. The method 1400 may be performed by or at a network entity (e.g., the base station 102/180, 410, 702), another wireless communications apparatus (e.g., the apparatus 1802 shown in FIG. 18), or one or more components thereof. According to various different aspects, one or more of the illustrated blocks of the method 1400 may be omitted, transposed, and/or contemporaneously performed. The method allows a UE to dynamically switch MCS table via MAC-CE. The method allows a UE to dynamically switch MCS tables via MAC-CE.

The method 1400 may be performed by an apparatus, such as MCS Table Configuration Component 198, as described above. In some implementations, the method 1400 is performed by processing logic, including hardware, firmware, software, or a combination thereof. In some implementations, the method 1400 is performed by a processor executing code stored in a non-transitory computer-readable medium (e.g., a memory).

At block 1402, the base station may transmit a radio resource control (RRC) configuration indicating a plurality of Modulation and Coding Scheme (MCS) tables. In an aspect, the RRC configuration is transmitted based on a capability of the UE to switch between the plurality of MCS tables. For example, referring to FIG. 7, base station 702 may transmit a RRC configuration indicating a plurality of MCS tables 716 (e.g., MCS tables 507, 509 in FIG. 5) to the UE 704.

In some aspects, the plurality of MCS tables are associated with different ranges of signal to noise ratios (SNRs). At least two of the plurality of MCS tables may share a partial overlap in ranges of the associated SNRs or SPEFs covered by each MCS table. For example, referring to FIG. 5, MCS tables 507, 509 may include MCSs for different SNR ranges. In another aspect, at least one MCS in different ones of the plurality of MCS tables are associated with a same SPEF subrange. For example, referring to FIG. 5, MCSs having indices referenced by partial overlap 511 may share a same corresponding SNR/SPEF subrange. In another aspect, the plurality of MCS tables respectively comprise a same quantity of MCSs. For example, referring to FIG. 5, MCS tables 507, 509 may each include 28 MCSs in the illustrated example, 32 MCSs represented by 5 bits in DCI in another example, or any other number of MCSs in a different example. The number of MCSs in MCS tables 507, 509 may be the same as the number of MCSs in MCS tables 501, 503, 505. In some aspects, the plurality of MCS tables includes a first MCS table associated with an enabled value for a pi/2 binary phase shift keying (BPSK) enabling parameter and a second MCS table associated with a disabled value for the pi/2 BPSK enabling parameter, wherein the enabled value is fixed for the first MCS table and the disabled value is fixed for the second MCS table. For example, referring to FIG. 5, MCS table 507 may be configured with a pi/2 BPSK enabling parameter that is enabled, while MCS table 509 may be configured with a pi/2 BPSK enabling parameter that is disabled.

At block 1404, the base station may transmit a medium access control (MAC) control element (MAC-CE) activating a MCS table among the plurality of MCS tables. For example, referring to FIG. 7, the base station 702 may transmit MAC-CE activating an MCS table among the plurality of MCS tables 728. In some aspects, the MCS table is activated based on a condition of a channel between the base station and the UE. For example, referring to FIG. 7, the base station 702 may determine a MCS table from the plurality of RRC-configured MCS tables 726 based on the identified channel conditions 718.

At block 1406, the base station may communicate data with a UE using an MCS in the activated MCS table. For example, referring to FIG. 7, the base station 702 may communicate with the UE 704 using the MCS in the activated MCS table 730.

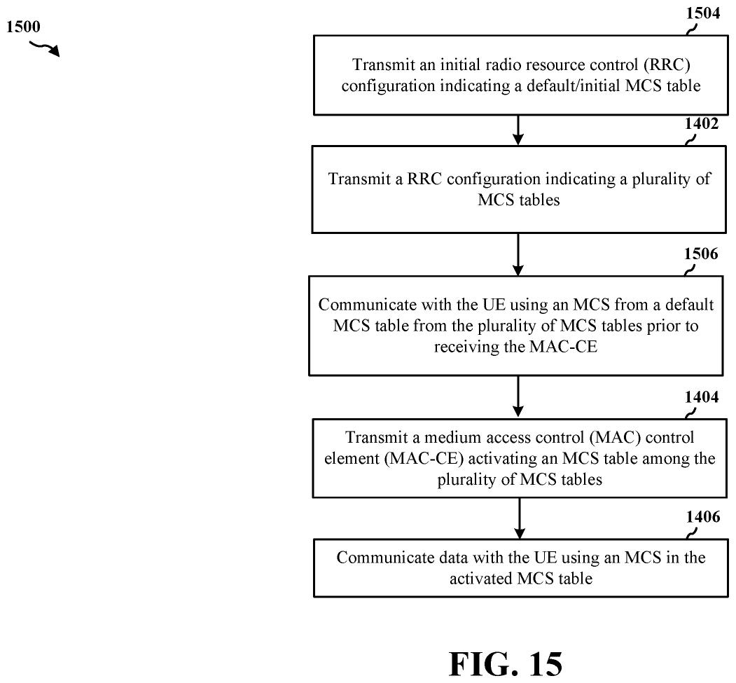

FIG. 15 is a flow chart method 1500 of MCS table switching. The method 1500 may be performed by or at a network entity (e.g., the base station 102/180, 410, 702), another wireless communications apparatus (e.g., the apparatus 1802 shown in FIG. 18), or one or more components thereof. According to various different aspects, one or more of the illustrated blocks of the method 1500 may be omitted, transposed, and/or contemporaneously performed. The method allows a UE to dynamically switch MCS table via MAC-CE.

The method 1500 may be performed by an apparatus, such as MCS Table Configuration Component 198, as described above. In some implementations, the method 1500 is performed by processing logic, including hardware, firmware, software, or a combination thereof. In some implementations, the method 1500 is performed by a processor executing code stored in a non-transitory computer-readable medium (e.g., a memory). In such methods 1500, blocks 1402, 1404, and 1406 are performed as described above in connection to FIG. 14.

At block 1504, the base station may transmit an initial RRC configuration indicating a default (or initial) MCS table. For example, referring to FIG. 7, at 712 the base station 702 transmits an initial RRC configuration indicating the plurality of MCS table to the UE 704.

At block 1506, the base station may receive communication from a UE using an MCS in the default MCS table prior to transmitting the MAC-CE. For example, referring to FIG. 7, at 727, the base station 702 communicates with the UE 704 using an MCS in the default MCS table 727 prior to the UE 704 receiving a MAC-CE.

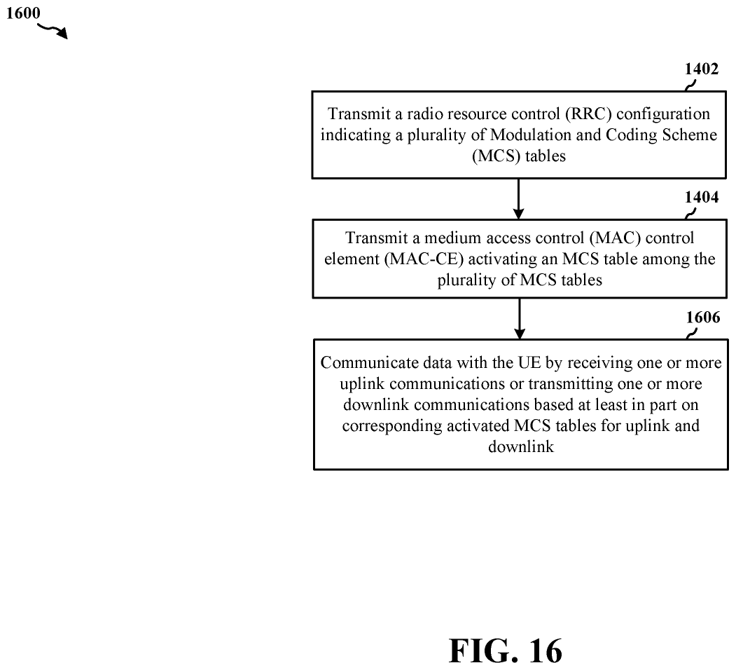

FIG. 16 is a flow chart method 1600 of MCS table switching. The method 1600 may be performed by or at a network entity (e.g., the base station 102/180, 410, 702), another wireless communications apparatus (e.g., the apparatus 1802 shown in FIG. 18), or one or more components thereof. According to various different aspects, one or more of the illustrated blocks of the method 1600 may be omitted, transposed, and/or contemporaneously performed. The method allows a UE to dynamically switch MCS table via MAC-CE.

The method 1600 may be performed by an apparatus, such as MCS Table Configuration Component 198, as described above. In some implementations, the method 1600 is performed by processing logic, including hardware, firmware, software, or a combination thereof. In some implementations, the method 1600 is performed by a processor executing code stored in a non-transitory computer-readable medium (e.g., a memory). In such methods 1600, blocks 1402 and 1406 are performed as described above in connection to FIG. 14.

In some aspects, at 1606, the base station may communicate with the UE by receiving one or more uplink communications or transmitting one or more downlink communications based at least in part on corresponding activated MCS tables for uplink and downlink. For example, referring to FIG. 7, the base station 702 may receive, one or more uplink communications 732 based at least in part on the dynamically switched MCS table that is indicated by the MAC-CE signal. In some aspects, the one or more uplink communications uses a transmit waveform type based at least in part on the activated MCS table.

FIG. 17 is a diagram 1700 illustrating an example of a hardware implementation for an apparatus 1702. The apparatus 1702 may be a UE or similar device, or the apparatus 1702 may be a component of a UE or similar device. The apparatus 1702 may include a cellular baseband processor 1704 (also referred to as a modem) and/or a cellular RF transceiver 1722, which may be coupled together and/or integrated into the same package, component, circuit, chip, and/or other circuitry.

In some aspects, the apparatus 1702 may accept or may include one or more subscriber identity modules (SIM) cards 1720, which may include one or more integrated circuits, chips, or similar circuitry, and which may be removable or embedded. The one or more SIM cards 1720 may carry identification and/or authentication information, such as an international mobile subscriber identity (IMSI) and/or IMSI-related key(s). Further, the apparatus 1702 may include one or more of an application processor 1706 coupled to a secure digital (SD) card 1708 and a screen 1710, a Bluetooth module 1712, a wireless local area network (WLAN) module 1714, a Global Positioning System (GPS) module 1716, and/or a power supply 1718.

The cellular baseband processor 1704 communicates through the cellular RF transceiver 1722 with the UE 104 and/or base station 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704.

In the context of FIG. 4, the cellular baseband processor 1704 may be a component of the UE 450 and may include the memory 460 and/or at least one of the TX processor 468, the RX processor 456, and/or the controller/processor 459. In one configuration, the apparatus 1702 may be a modem chip and/or may be implemented as the baseband processor 1704, while in another configuration, the apparatus 1702 may be the entire UE (e.g., the UE 450 of FIG. 4) and may include some or all of the abovementioned components, circuits, chips, and/or other circuitry illustrated in the context of the apparatus 1702. In one configuration, the cellular RF transceiver 1722 may be implemented as at least one of the transmitter 454TX and/or the receiver 454RX.

The reception component 1730 may be configured to receive signaling on a wireless channel, such as signaling from a base station 102/180 or UE 104. The transmission component 1734 may be configured to transmit signaling on a wireless channel, such as signaling to a base station 102/180 or UE 104. The communication manager 1732 may coordinate or manage some or all wireless communications by the apparatus 1702, including across the reception component 1730 and the transmission component 1734.

The reception component 1730 may provide some or all data and/or control information included in received signaling to the communication manager 1732, and the communication manager 1732 may generate and provide some or all of the data and/or control information to be included in transmitted signaling to the transmission component 1734. The communication manager 1732 may include the various illustrated components, including one or more components configured to process received data and/or control information, and/or one or more components configured to generate data and/or control information for transmission.

The communications manager 1732 includes a MCS Configuration Transmission Component 1742 that is configured to receive a RRC configuration indicating a plurality of MCS tables, e.g., as described in connection with block 802 from FIG. 8, and to communicate with a base station using an MCS in the activated MCS table, e.g., as described in connection with block 806 from FIG. 8. The communication manager 1732 further includes a MCS Activation Component 1744 and is configured to receive a MAC-CE activating an MCS table among the plurality of MCS tables e.g., as described in connection with block 804 from FIG. 8.

In some aspects, the communications manager 1732 further includes an Uplink Reception Component 1746 that is configured to transmit one or more uplink communications based at least in part on the activated MCS table, e.g., as described in connection with block 1008 from FIG. 10. In some aspects, the communications manager 1732 further includes a Feedback Component 1748 that is configured as or otherwise support a means for supporting a CSF session, e.g., as described in connection with block 1002 from FIG. 10. In some aspects, the communications manager 1732 further includes a Report Component 1750 that is configured to receive a channel state information reference signal (CSI-RS) and transmit a CSF report based on receiving the CSI-RS while a different MCS table is activated during the CSF session, wherein the CSF report corresponds to a MCS table which was active on: a slot where the CSI-RS is received, on a slot where the DCI is received, or on a channel state information (CSI) reference slot associated with the CSF report, e.g., as described in connection with block 1002 from FIG. 10.

The apparatus 1702 may include additional components that perform some or all of the blocks, operations, signaling, etc. of the algorithm(s) in the aforementioned call flow diagram(s) and/or flowchart(s) of FIGS. 7-13. As such, some or all of the blocks, operations, signaling, etc. in the aforementioned call flow diagram(s) and/or flowchart(s) of FIGS. 7-13 may be performed by one or more components and the apparatus 1702 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the baseband processor 1704, may include means for: receiving a radio resource control (RRC) configuration indicating a plurality of Modulation and Coding Scheme (MCS) tables; receiving a medium access control (MAC) control element (MAC-CE) activating a MCS table among the plurality of MCS tables; and communicating with a base station using an MCS in the activated MCS table.

In one configuration, the apparatus 1702, and in particular the baseband processor 1704, may include means for: communicating with the base station using an MCS from a default MCS table from the plurality of MCS tables prior to receiving the MAC-CE.

In one configuration, the apparatus 1702, and in particular the baseband processor 1704, may include means for: receiving an initial RRC configuration prior to the RRC configuration indicating the plurality of MCS tables, wherein the initial RRC configuration indicates the default MCS table.

In one configuration, the apparatus 1702, and in particular the baseband processor 1704, may include means for: supporting a Channel State Feedback (CSF) session by: receiving a downlink control information (DCI) scheduling a channel state feedback (CSF) report; receiving a channel state information reference signal (CSI-RS); and transmitting a CSF report based on receiving the CSI-RS while a different MCS table is activated during the CSF session, and wherein the CSF report corresponds to a MCS table which was active on: a slot where the CSI-RS is received, on a slot where the DCI is received, or on a channel state information (CSI) reference slot associated with the CSF report

In one configuration, the apparatus 1702, and in particular the baseband processor 1704, may include means for: communicating with the base station by transmitting one or more uplink communications or receiving one or more downlink communications based at least in part on corresponding activated MCS tables for uplink and downlink.

In one configuration, the apparatus 1702, and in particular the baseband processor 1704, may include means for: receiving or transmitting an initial data transmission associated with a hybrid automatic repeat request (HARQ) process using an MCS from a first active MCS table; and wherein the MAC-CE activating a second MCS table instead of the first active MCS table is received prior to a termination of the HARQ process, and wherein the communication with the base station further comprises receiving or transmitting one or more HARQ retransmission of the initial data transmission based at least in part on the first active MCS table active during the initial data transmission.

In one configuration, the apparatus 1702, and in particular the baseband processor 1704, may include means for: receiving or transmit an initial data transmission associated with a HARQ process using an MCS from a first active MCS table; and wherein the MAC-CE activating a second MCS table instead of the first active MCS table is received prior to a termination of the HARQ process, wherein, in response to the MAC-CE, the HARQ process is aborted at a moment where the second MCS table becomes active, and wherein the communication with the base station further comprises receiving or transmitting the initial data transmission in another HARQ process using the second MCS table activated by the MAC-CE.

In one configuration, the apparatus 1702, and in particular the baseband processor 1704, may include means for: receiving downlink control information (DCI) indicating an MCS index and a new data indicator (NDI), wherein the MCS index is associated with the MCS in a currently active MCS table.

The aforementioned means may be one or more of the aforementioned components of the apparatus 1702 configured to perform the functions recited by the aforementioned means. As described supra, the apparatus 1702 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

FIG. 18 is a diagram 1800 illustrating an example of a hardware implementation for an apparatus 1802. The apparatus 1802 may be a base station or similar device or system, or the apparatus 1802 may be a component of a base station or similar device or system. The apparatus 1802 may include a baseband unit 1804. The baseband unit 1804 may communicate through a cellular RF transceiver. For example, the baseband unit 1804 may communicate through a cellular RF transceiver with a UE 104, such as for downlink and/or uplink communication, and/or with a base station 102/180, such as for IAB.

The baseband unit 1804 may include a computer-readable medium/memory, which may be non-transitory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 410 and may include the memory 476 and/or at least one of the TX processor 416, the RX processor 470, and the controller/processor 475.

The reception component 1830 may be configured to receive signaling on a wireless channel, such as signaling from a UE 104 or base station 102/180. The transmission component 1834 may be configured to transmit signaling on a wireless channel, such as signaling to a UE 104 or base station 102/180. The communication manager 1832 may coordinate or manage some or all wireless communications by the apparatus 1802, including across the reception component 1830 and the transmission component 1834.

The reception component 1830 may provide some or all data and/or control information included in received signaling to the communication manager 1832, and the communication manager 1832 may generate and provide some or all of the data and/or control information to be included in transmitted signaling to the transmission component 1834. The communication manager 1832 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communications manager 1832 includes a MCS Configuration Transmission Component 1842 that is configured to transmit a RRC configuration indicating a plurality of MCS tables, e.g., as described in connection with block 1402 from FIG. 14, and to communicate with a UE using an MCS in the activated MCS table, e.g., as described in connection with block 1406 from FIG. 14. The communication manager 1832 further includes a MCS Activation Component 1844 and is configured to transmit a MAC-CE activating an MCS table among the plurality of MCS tables e.g., as described in connection with block 1404 from FIG. 14.

In some aspects, the communications manager 1832 further includes an Uplink Reception Component 1846 that is configured to receive one or more uplink communications based at least in part on the activated MCS table, e.g., as described in connection with block 1606 from FIG. 16.

The apparatus 1802 may include additional components that perform some or all of the blocks, operations, signaling, etc. of the algorithm(s) in the aforementioned call flow diagram(s) and/or flowchart(s) of FIGS. 7 and 14-16. As such, some or all of the blocks, operations, signaling, etc. in the aforementioned call flow diagram(s) and/or flowchart(s) of FIGS. 7 and 14-16 may be performed by a component and the apparatus 1802 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, may include means for: transmitting a radio resource control (RRC) configuration indicating a plurality of Modulation and Coding Scheme (MCS) tables; transmitting a medium access control (MAC) control element (MAC-CE) activating an MCS table among the plurality of MCS tables; and communicating with a user equipment (UE) using an MCS in the activated MCS table.

In one configuration, the apparatus 1802, and in particular the baseband unit 1804, may include means for: communicating with the UE using an MCS from a default MCS table from the plurality of MCS tables prior to receiving the MAC-CE.

In one configuration, the apparatus 1802, and in particular the baseband unit 1804, may include means for: transmitting an initial RRC configuration prior to the RRC indicating the plurality of MCS tables, wherein the initial RRC configuration indicates the default MCS table.

In one configuration, the apparatus 1802, and in particular the baseband unit 1804, may include means for: communicating with the UE by receiving one or more uplink communications or transmitting one or more downlink communications based at least in part on corresponding activated MCS tables for uplink and downlink.

The aforementioned means may be one or more of the aforementioned components of the apparatus 1802 configured to perform the functions recited by the aforementioned means. As described supra, the apparatus 1302 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

The subject matter described herein can be implemented to realize one or more benefits or advantages. For instance, the described wireless communication techniques can be used by a UE, a base station or other devices that can perform wireless communication techniques. Accordingly, aspects of the present disclosure allow for a dynamically based MCS table switching option for both downlink and uplink to allow a more efficient and flexible support of higher order QAM options and new constellations types that are expected to be introduced. In one aspect, a RRC configuration may be used to indicate a plurality of MCS tables. In another aspect, a MAC-CE may be used to activate a MCS among the plurality of MCS tables. In a further aspect, the UE may communicate with the base station using the MCS in the activated MCS table.

Aspects of the present disclosure allow a more efficient usage of already existing MCS table options. For instance, the present disclosure allows adaptive selection of MCS table with the most appropriate constellation type and code rates per scenario from a portfolio of MCS tables optimizes for different conditions (e.g., channel conditions, UE impairments, power saving mode, power limited regime, etc.). In addition, the dynamic MCS table switching provides improved link efficiency, improved max throughput, and improved coverage. Moreover, it would be helpful to allow better flexibility for any future specification evolutions, including higher modulation orders adoption, introduction of additional constellation types (APSK, cross QAM, etc.), adoption of multi-level coding (MLC) techniques, and new coding approaches (e.g., new codec types, addition of outer codes, etc.).

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### Some Additional Examples

The following examples are illustrative only and may be combined with aspects of other embodiments or teachings described herein, without limitation.

Aspect 1. An apparatus for wireless communication at a user equipment (UE), comprising:
a memory; and
at least one processor coupled to the memory and configured to:
receive a radio resource control (RRC) configuration indicating a plurality of Modulation and Coding Scheme (MCS) tables;
receive a medium access control (MAC) control element (MAC-CE) activating a MCS table among the plurality of MCS tables; and
communicate with a base station using an MCS in the activated MCS table.

Aspect 2. The apparatus of aspect 1, wherein the plurality of MCS tables are associated with different ranges of signal to noise ratios (SNRs), wherein at least two of the plurality of MCS tables share a partial overlap in ranges of the SNRs.

Aspect 3. The apparatus of aspects 1 or 2, wherein at least one MCS in different ones of the plurality of MCS tables are associated with a same spectral efficiency range.

Aspect 4. The apparatus of any of the aspects 1 to 3, wherein the MCS table is activated based at least in part on a condition of a channel between the base station and the UE.

Aspect 5. The apparatus of any of the aspects 1 to 4, wherein the RRC configuration is received based at least in part on a capability of the UE to dynamically switch between the plurality of MCS tables.

Aspect 6. The apparatus of any of the aspects 1 to 5, wherein the at least one processor is further configured to:

communicate with the base station using an MCS from a default MCS table from the plurality of MCS tables prior to receiving the MAC-CE.

Aspect 7. The apparatus of any of the aspects 1 to 6, wherein the at least one processor is further configured to:

receive an initial RRC configuration prior to the RRC configuration indicating the plurality of MCS tables, wherein the initial RRC configuration indicates the default MCS table.

Aspect 8. The apparatus of any of the aspects 1 to 7, wherein the at least one processor is further configured to support a Channel State Feedback (CSF) session by:
receiving a downlink control information (DCI) scheduling a channel state feedback (CSF) report;
receiving a channel state information reference signal (CSI-RS); and
transmitting a CSF report based on receiving the CSI-RS while a different MCS table is activated during the CSF session, and wherein the CSF report corresponds to a MCS table which was active on:
a slot where the CSI-RS is received,
on a slot where the DCI is received, or
on a channel state information (CSI) reference slot associated with the CSF report.

Aspect 9. The apparatus of any of the aspects 1 to 8, wherein the plurality of MCS tables respectively comprise a same quantity of MCS options in each MCS table.

Aspect 10. The apparatus of any of the aspects 1 to 9, wherein the at least one processor is further configured to:

Communicate data with the base station by transmitting one or more uplink communications or receiving one or more downlink communications based at least in part on corresponding activated MCS tables for uplink and downlink.

Aspect 11. The apparatus of any of the aspects 1 to 10, wherein the one or more uplink communications uses a transmit waveform type based at least in part on the activated MCS table.

Aspect 12. The apparatus of any of the aspects 1 to 11, wherein the at least one processor is further configured to:
receive or transmit an initial data transmission associated with a hybrid automatic repeat request (HARQ) process using an MCS from a first active MCS table; and
wherein, in response to the MAC-CE, a second MCS table signaled by the MAC-CE instead of the first active MCS table is activated prior to a termination of the HARQ process at a slot determined by an activation time of the second MCS table, and
wherein the communication with the base station further comprises receiving or transmitting one or more HARQ retransmission of the initial data transmission based at least in part on the first MCS table that was active during the initial data transmission.

Aspect 13. The apparatus of any of the aspects 1 to 12, wherein the at least one processor is further configured to:
receive or transmit an initial data transmission associated with a HARQ process using an MCS from a first active MCS table; and
wherein the MAC-CE activating a second MCS table instead of the first active MCS table is received prior to a termination of the HARQ process,
wherein, in response to the MAC-CE, the HARQ process is aborted at a moment where the second MCS table becomes active, and
wherein the communication with the base station further comprises receiving or transmitting the initial data transmission in another HARQ process using the second MCS table activated by the MAC-CE.

Aspect 14. The apparatus of any of the aspects 1 to 13, wherein the plurality of MCS tables includes a first MCS table associated with an enabled value for a pi/2 binary phase shift keying (BPSK) enabling parameter and a second MCS table associated with a disabled value for the pi/2 BPSK enabling parameter, wherein the enabled value is fixed for the first MCS table and the disabled value is fixed for the second MCS table.

Aspect 15. The apparatus of any of the aspects 1 to 14, wherein the at least one processor is further configured to:

receive downlink control information (DCI) indicating an MCS index and a new data indicator (NDI), wherein the MCS index is associated with the MCS in a currently active MCS table.

Aspect 16. The apparatus of any of the aspects 1 to 15, wherein the MCS table is activated adaptively based on a match between a current signal to noise ratio (SNR) of the apparatus and a SNR range supported by a more convenient MCS table from the plurality of MCS tables, wherein a subsequent MCS table is determined to be more convenient than a previously active MCS table based on overlapping between MCS indexes of the previously active MCS table and the subsequent MCS table and when the current SNR increases toward a last MCS index of the previously active MCS table or decreases toward a first MCS index of the previously active MCS table.

Aspect 17. The apparatus of any of the aspects 1 to 16, wherein the MAC-CE activating the MCS table is received in response to a channel state feedback (CSF) report of the apparatus indicating an index corresponding to the MCS table.

Aspect 18. The apparatus of any of the aspects 1 to 16, wherein the MAC-CE activating the MCS table is received in response to a request indication from the apparatus to switch to a different MCS table.

Aspect 19. The apparatus of any of the aspects 1 to 18, wherein the plurality of MCS tables are associated with different types of constellations, code types, or transmission schemes.

Aspect 20. An apparatus of for wireless communication at a base station (BS), comprising:
a memory; and
at least one processor coupled to the memory and configured to:
transmit a radio resource control (RRC) configuration indicating a plurality of Modulation and Coding Scheme (MCS) tables;
transmit a medium access control (MAC) control element (MAC-CE) activating an MCS table among the plurality of MCS tables; and
communicate data with a user equipment (UE) using an MCS in the activated MCS table.

Aspect 21. The apparatus of aspect 20, wherein the plurality of MCS tables are associated with different ranges of signal to noise ratios (SNRs), wherein at least two of the plurality of MCS tables share a partial overlap in ranges of the SNRs.

Aspect 22. The apparatus of aspect 20 or 21, wherein at least one MCS in different ones of the plurality of MCS tables are associated with a same spectral efficiency range.

Aspect 23. The apparatus of any of the aspects 20 to 22, wherein the MCS table is activated based at least in part on a condition of a channel between the base station and the UE.

Aspect 24. The apparatus of any of the aspects 19 to 23, wherein the RRC configuration is received based at least in part on a capability of the UE to dynamically switch between the plurality of MCS tables.

Aspect 25. The apparatus of any of the aspects 19 to 24, wherein the at least one processor is further configured to:

communicate with the UE using an MCS from a default MCS table from the plurality of MCS tables prior to receiving the MAC-CE.

Aspect 26. The apparatus of any of the aspects 19 to 25, wherein the at least one processor is further configured to:

transmit an initial RRC configuration indicating a default MCS table.

Aspect 27. The apparatus of any of the aspects 19 to 26, wherein the plurality of MCS tables respectively comprise a same quantity of MCS options in each MCS table.

Aspect 28. The apparatus of any of the aspects 19 to 27, wherein the at least one processor is further configured to:

communicate with the UE by receiving one or more uplink communications or transmitting one or more downlink communications based at least in part on corresponding activated MCS tables for uplink and downlink

Aspect 29. A method of wireless communication by a user equipment (UE), comprising:
receiving a radio resource control (RRC) configuration indicating a plurality of Modulation and Coding Scheme (MCS) tables;
receiving a medium access control (MAC) control element (MAC-CE) activating an MCS table among the plurality of MCS tables; and
communicating with a base station using an MCS in the activated MCS table.

Aspect 30. A method of wireless communication at a base station (BS), comprising:
transmitting a radio resource control (RRC) configuration indicating a plurality of Modulation and Coding Scheme (MCS) tables;
transmitting a medium access control (MAC) control element (MAC-CE) activating an MCS table among the plurality of MCS tables; and
communicating with a user equipment (UE) using an MCS in the activated MCS table.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication at a user equipment (UE), comprising:
a memory; and
at least one processor coupled to the memory and configured to:
receive a radio resource control (RRC) configuration indicating a plurality of Modulation and Coding Scheme (MCS) tables;
receive a medium access control (MAC) control element (MAC-CE) activating an MCS table among the plurality of MCS tables; and
communicate data with a base station using an MCS in the activated MCS table.

2. The apparatus of claim 1, wherein the plurality of MCS tables are associated with different ranges of signal to noise ratios (SNRs), wherein at least two of the plurality of MCS tables share a partial overlap in ranges of the SNRs.

3. The apparatus of claim 1, wherein at least one MCS in different ones of the plurality of MCS tables are associated with a same spectral efficiency range.

4. The apparatus of claim 1, wherein the MCS table is activated based at least in part on a condition of a channel between the base station and the UE.

5. The apparatus of claim 1, wherein the RRC configuration is received based at least in part on a capability of the UE to dynamically switch between the plurality of MCS tables.

6. The apparatus of claim 1, wherein the at least one processor is further configured to:
communicate with the base station using an MCS from a default RRC configured MCS table prior to receiving a first activating MAC-CE.

7. The apparatus of claim 6, wherein the at least one processor is further configured to:
receive an initial RRC configuration, wherein the initial RRC configuration indicates the default MCS table.

8. The apparatus of claim 1, wherein the at least one processor is further configured to support a Channel State Feedback (CSF) session by:
receiving a downlink control information (DCI) scheduling a channel state feedback (CSF) report;
receiving a channel state information reference signal (CSI-RS); and
transmitting a CSF report based on receiving the CSI-RS while a different MCS table is activated during the CSF session, and wherein the CSF report corresponds to a MCS table which was active on one of:
a slot where the CSI-RS is received,
on a slot where the DCI is received, or
on a channel state information (CSI) reference slot associated with the CSF report.

9. The apparatus of claim 1, wherein the plurality of MCS tables respectively comprise a same quantity of MCS options in each MCS table.

10. The apparatus of claim 1, wherein the at least one processor is further configured to:
communicate data with the base station by transmitting one or more uplink communications or receiving one or more downlink communications based at least in part on corresponding activated MCS tables for uplink and downlink.

11. The apparatus of claim 10, wherein the one or more uplink communications uses a transmit waveform type based at least in part on the activated MCS table.

12. The apparatus of claim 1, wherein the at least one processor is further configured to:
receive or transmit an initial data transmission associated with a hybrid automatic repeat request (HARQ) process using an MCS from a first active MCS table; and
wherein, in response to the MAC-CE, a second MCS table signaled by the MAC-CE instead of the first active MCS table is activated prior to a termination of the HARQ process at a slot determined by an activation time of the second MCS table,
wherein the communication with the base station further comprises receiving or transmitting one or more HARQ retransmission of the initial data transmission based at least in part on the first MCS table that was active during the initial data transmission.

13. The apparatus of claim 1, wherein the at least one processor is further configured to:
receive or transmit an initial data transmission associated with a HARQ process using an MCS from a first active MCS table,
wherein the MAC-CE activating a second MCS table instead of the first active MCS table is received prior to a termination of the HARQ process,
wherein, in response to the MAC-CE, the HARQ process is aborted at a moment where the second MCS table becomes active,
wherein the communication with the base station further comprises receiving or transmitting the initial data transmission in another HARQ process using the second MCS table activated by the MAC-CE.

14. The apparatus of claim 1, wherein the plurality of MCS tables includes a first MCS table associated with an enabled value for a pi/2 binary phase shift keying (BPSK) enabling parameter and a second MCS table associated with a disabled value for the pi/2 BPSK enabling parameter, wherein the enabled value is fixed for the first MCS table and the disabled value is fixed for the second MCS table.

15. The apparatus of claim 1, wherein the at least one processor is further configured to:
receive downlink control information (DCI) indicating an MCS index and a new data indicator (NDI), wherein the MCS index is associated with the MCS in a currently active MCS table.

16. The apparatus of claim 1, wherein the MCS table is activated adaptively based on a match between a current signal to noise ratio (SNR) of the apparatus and a SNR range supported by a more convenient MCS table from the plurality of MCS tables, wherein a subsequent MCS table is determined to be more convenient than a previously active MCS table based on overlapping between MCS indexes of the previously active MCS table and the subsequent MCS table and when the current SNR increases toward a last MCS index of the previously active MCS table or decreases toward a first MCS index of the previously active MCS table.

17. The apparatus of claim 16, wherein the MAC-CE activating the MCS table is received in response to a channel state feedback (CSF) report of the apparatus indicating an index corresponding to the MCS table.

18. The apparatus of claim 16, wherein the MAC-CE activating the MCS table is received in response to a request indication from the apparatus to switch to a different MCS table.

19. The apparatus of claim 1, wherein the plurality of MCS tables are associated with different types of constellations, code types, or transmission schemes.

20. An apparatus for wireless communication at a base station (BS), comprising:
a memory; and
at least one processor coupled to the memory and configured to:
transmit a radio resource control (RRC) configuration indicating a plurality of Modulation and Coding Scheme (MCS) tables;
transmit a medium access control (MAC) control element (MAC-CE) activating an MCS table among the plurality of MCS tables; and
communicate data with a user equipment (UE) using an MCS in the activated MCS table.

21. The apparatus of claim 20, wherein the plurality of MCS tables are associated with different ranges of signal to noise ratios (SNRs), wherein at least two of the plurality of MCS tables share a partial overlap in ranges of the SNRs.

22. The apparatus of claim 20, wherein at least one MCS in different ones of the plurality of MCS tables are associated with a same spectral efficiency range.

23. The apparatus of claim 20, wherein the MCS table is activated based at least in part on a condition of a channel between the base station and the UE.

24. The apparatus of claim 20, wherein the RRC configuration is received based at least in part on a capability of the UE to dynamically switch between the plurality of MCS tables.

25. The apparatus of claim 20, wherein the at least one processor is further configured to:
communicate with the UE using an MCS from a default MCS table from the plurality of MCS tables prior to receiving the MAC-CE.

26. The apparatus of claim 25, wherein the at least one processor is further configured to:
transmit an initial RRC configuration indicating a default MCS table.

27. The apparatus of claim 20, wherein the plurality of MCS tables respectively comprise a same quantity of MCS options in each MCS table.

28. The apparatus of claim 20, wherein the at least one processor is further configured to:
communicate with the UE by receiving one or more uplink communications or transmitting one or more downlink communications based at least in part on corresponding activated MCS tables for uplink and downlink.

29. A method of wireless communication by a user equipment (UE), comprising:
receiving a radio resource control (RRC) configuration indicating a plurality of Modulation and Coding Scheme (MCS) tables;
receiving a medium access control (MAC) control element (MAC-CE) activating an MCS table among the plurality of MCS tables; and
communicating data with a base station using an MCS in the activated MCS table.

30. A method of wireless communication at a base station (B S), comprising:
transmitting a radio resource control (RRC) configuration indicating a plurality of Modulation and Coding Scheme (MCS) tables;
transmitting a medium access control (MAC) control element (MAC-CE) activating an MCS table among the plurality of MCS tables; and
communicating data with a user equipment (UE) using an MCS in the activated MCS table.
